(19) United States
(12) Patent Application Publication
(10) Pub. No.: US 2023/0193516 A1
(43) Pub. Date: Jun. 22, 2023

(54) BICOMPONENT FABRICS

(71) Applicant: Ascend Performance Materials Operations LLC, Houston, TX (US)

(72) Inventors: Albert Ortega, Houston, TX (US); Kevin Urman, Houston, TX (US); Ryan Hensarling, Houston, TX (US)

(73) Assignee: Ascend Performance Materials Operations LLC, Houston, TX (US)

(21) Appl. No.: 18/066,753

(22) Filed: Dec. 15, 2022

Related U.S. Application Data
(60) Provisional application No. 63/291,022, filed on Dec. 17, 2021.

(51) Int. Cl. D01F 1/10; D01F 6/60; D01F 6/06

(52) U.S. Cl. CPC D01F 1/103; D01F 6/06; D01F 6/60; D10B 2321/022; D10B 2331/02; D10B 2401/13

(57) ABSTRACT

An AM/AV fabric comprising base fibers comprising a base polymer composition and AM/AV fibers comprising an AM/AV polymer composition comprising an AM/AV polymer and an AM/AV compound. The base fibers and the AM/AV fibers are intermingled with one another; and the fabric demonstrates an Escherichia coli efficacy log reduction greater than 4.0, as measured in accordance with ASTM E3160 (2018) and a particle filtration efficiency greater than 35%.

### CROSS-REFERENCE

This application is related to and claims priority to U.S. Provisional Pat. Application No. 63/291,022 filed December 17^{th}, 2021, which is incorporated herein by reference.

### FIELD

The present disclosure relates to a bicomponent fabric having antiviral and/or antimicrobial and/or antiodor (AM/AV) properties. The fabric comprises base fibers and AM/AV fibers.

### BACKGROUND

There is a growing interest in (polymer) fabrics having antiodor and/or antiviral and/or antimicrobial (AM/AV) properties. These products are used for many applications, including industrial cloth, medical apparel, masks, and filtration devices.

Conventional polymer fabrics, e.g., olefin-based fabrics such as polypropylene or polyethylene fabrics, are known and are used in liquid and/or gas filtration applications. These fabrics are designed to filter smaller undesired particles from various fluids, e.g., vapors or liquids. These conventional fabrics are do not have AM/AV properties, however. And, as such, these fabrics cannot kill pathogens that may be present in the fluid being filtered. Further, olefin polymers, e.g., polypropylene, have a relatively low melt point limiting its use in high temperature AM/AV applications. In addition, fabrics made from olefin polymers have been found to degrade significantly when exposed to gamma radiation, which is one conventional method used to sterilize medical fabrics.

Some AM/AV fabrics (and fibers) are known as well. For example, some coarse carpet yarns and fabrics with antimicrobial properties are also known. U.S. Pat. 4,701,518 discloses an antimicrobial nylon prepared in water with a zinc compound phosphorus compound to form carpet fibers. The process produces nylon fibers for carpets having 18 denier per filament (dpf), and are prepared by conventional melt polymerization. Such carpet fibers typically have average diameters that are well above 30 microns, which are generally unsuitable for (fine) filtration applications.

Although some references may disclose filtration fabric and others may disclose AM/AV fabrics, a need exists for fabrics that demonstrate a synergistic combination of filtration and AM/AV performance.

### SUMMARY

The disclosure relates to an AM/AV fabric, comprising (greater than 25 wt%) base fibers comprising a base polymer, e.g., olefin, e.g., polypropylene, composition and having a base fiber charge; and AM/AV fibers comprising an AM/AV polymer composition comprising an AM/AV polymer, e.g., polyamide, and optionally a supplemental polymer different from the AM/AV polymer, and an AM/AV compound, e.g., zinc or copper or a combination thereof, and having an AM/AV fiber charge or no charge and/or a basis weight greater than 5 gsm. The base fiber charge may be less than the AM/AV fiber charge. The base fibers and the AM/AV fibers are intermingled with one another. The fabric demonstrates an Escherichia coli efficacy log reduction greater than 4.0, as measured in accordance with ASTM E3160 (2018) and a particle filtration efficiency greater than 35% and/or a filtration efficiency greater than 20% and/or a pressure drop greater than 1 mm H₂O/cm² and/or an air permeability greater than 20 cfm/ft² at a mean flow pore size (MFP) of at least 7 microns. The base polymer or the AM/AV polymer may comprise comprises a charge agent, preferably a stearate and/or a wax.

The disclosure also relates a process for producing an AM/AV fabric, the process comprising: intermingling AM/AV fibers comprising an AM/AV polymer composition and base fibers comprising a base polymer composition and to form a fabric web; charging the fabric web to form the AM/AV fabric; wherein the AM/AV fabric demonstrates an Escherichia coli efficacy log reduction greater than 4.0, as measured in accordance with ASTM E3160 (2018) and a particle filtration efficiency greater than 35%. The process may further comprise blowing the AM/AV polymer composition to form the AM/AV fibers; and blowing the base polymer composition to form the base fibers; wherein the blowing of the fibers effectuates the intermingling. The base fibers may have a base fiber charge and the AM/AV fibers have an AM/AV fiber charge, and wherein the base fiber charge may be less than the AM/AV fiber charge.

The disclosure also relates to an AM/AV fabric, comprising: base fibers comprising a base polymer composition comprising polypropylene; and AM/AV fibers comprising an AM/AV polymer composition comprising an AM/AV polymer comprising polyamide and an AM/AV compound comprising zinc or copper or a combination thereof and an optional supplemental polymer comprising an olefin polymer; wherein base fibers and the AM/AV fibers are intermingled with one another; and wherein the fabric demonstrates an Escherichia coli efficacy log reduction greater than 4.0, as measured in accordance with ASTM E3160 (2018) and a particle filtration efficiency greater than 35%.

### DESCRIPTION OF THE FIGURES

FIG. 1 is a graph showing the synergistic combination of AM/AV performance and particle filtration efficiency for exemplary AM/AV fabrics.

FIG. 2 is a graph showing the synergistic combination of AM/AV performance and ATI filtration efficiency (85 1pm) for exemplary AM/AV fabrics.

FIG. 3 is a graph showing the synergistic combination of AM/AV performance and particle filtration efficiency (60 1pm) for exemplary AM/AV fabrics.

### DETAILED DESCRIPTION

### Introduction

As noted above, conventional filtration fabrics often comprise fibers made of olefin polymers. These fibers have been shown to be effective in filtration applications. These fabrics are designed to filter smaller undesired particles from various fluids, e.g., vapors or liquids. These known fabrics suffer from many shortcomings, however, not the least of which being that they do not have “built-in” AM/AV properties and are unable to reduce or eliminate (kill) bacteria, viruses, or other microbials. Some AM/AV fabrics (and fibers) are known as well. But these known AM/AV fibers are often coarse and are highly ineffective when employed in (fine) filtration applications, perhaps due to the coarse, high denier nature of the fibers. Other AM/AV fibers are also known, e.g., nylon fibers. These fibers may lack the filtration performance of olefin-based fibers. Still further, the pure AM/AV fabrics typically are not (sufficiently) charged materials, and as such, lack the filtration benefits associated therewith. And production of these fibers raises additional process and cost problems.

It has now been discovered that certain bicomponent fabrics are able to achieve a desirable combination of filtration and AM/AV performance, while still maintaining structure and processability necessary for typical filtration applications. In some cases, base fibers and AM/AV fibers may be intermingled with one another to provide a fabric having a synergistic combination of performance features, e.g., particle filtration efficiency (contributed at least in part by the base fibers) along with AM/AV efficacy (contributed at least in part by the AM/AV fibers). The combination of the base fibers and the AM/AV fibers is particularly advantageous in the filtration space where it is desirable to not simply filter pathogens, but also to kill them. The AM/AV fabrics (made from or comprising the AM/AV compounds) demonstrate efficacy against odor, microbials, bacteria, viruses, fungi, or parasites, or combinations thereof along with filtration performance.

In addition, conventional AM/AV fabrics/fibers typically are not charged or are not able to hold a charge. The inventors have now found that, using the disclosed AM/AV polymer compositions, the ability of the resultant AM/AV fibers to take and hold a charge is advantageously improved. This improvement contributes to an increased overall charge on the fabric (base fibers and AM/AV fibers), which beneficially improves filtration.

Also, some conventional olefin fabrics that are employed in filtration applications must be treated in an effort to make these fabrics more hygroscopic/hydrophilic. Advantageously, the fabrics discussed herein do not require such treatment. And as a result, these costly treatment steps can be reduced or eliminated, which, in turn, provides for significant process efficiencies. In some particular cases, and without being bound by theory, it is postulated that that the hygroscopic nature of some polymers, e.g., the AM/AV fibers, pulls in fluids and allows the AM/AV compounds to interact with the fluids to counter/combat them, so as to retard or eliminate the accompanying odor, fungi, microbials, and/or viruses and promote a more healthy environment.

### AM/AV Fabrics

The present disclosure relates to AM/AV fabrics having a synergistic combination of filtration and AM/AV properties. The AM/AV fabrics comprise AM/AV fibers comprising (made from) an AM/AV polymer composition and base fibers comprising (made from) a base polymer composition, which are intermingled with one another. The AM/AV polymer composition comprises polymer and an AM/AV compound, and the AM/AV compound contributes to the AM/AV properties of the AM/AV fibers/fabric. The synergistic combination of the base fibers and the AM/AV fibers contribute to the aforementioned combination of performance features, e.g., an Escherichia coli efficacy log reduction greater than 4.0 and a particle filtration efficiency greater than 35%. As shown in the Examples below, the disclosed AM/AV fabrics demonstrate superiority over conventional fabrics that employ a single type of fiber, e.g., a pure olefin fabric or a pure nylon fabric.

The AM/AV fabric may be a fabric or mat or collection of fibers, and the AM/AV fabric, in some cases, may contain multiple layers (although single layer fabrics are contemplated).

In some cases, at least some of the fibers of the AM/AV fabric are electrically charged. In some embodiments, the AM/AV fibers are charged. In some embodiments, both the base fibers and the AM/AV fibers have some degree of charge. For example, the fabric/fiber web may be charged during the production process, and as a result, some of the fibers may retain (hold) the charge. It is known that electric charge may contribute positively to filtration performance.

Some polymers are more susceptible to holding a charge. Without being bound by theory, it is postulated that, in some embodiments, the AM/AV polymer composition, which in some cases includes a charge agent, provides for charged AM/AV fibers. In contrast, conventional AM/AV polymer compositions with the same polymers, e.g., but without the charge agent, are unable to take and/or hold a charge. As a result, fibers formed from these conventional polymer compositions may be less effective in filtration, e.g., they do not possess the advantageous filtration performance features possessed by the disclosed fibers.

In some embodiments, the base fibers are electrically charged, e.g., the base fibers have a base fiber charge. The charge, in some cases may be expressed in a voltage drop. For example, the base fiber charge may be greater than 0.01 V, e.g., greater than 0.1 V, greater than 0.3 V, greater than 0.5 V, greater than 1 V, greater than 3 V, greater than 5 V, greater than 10 V, or greater than 15 V. In terms of upper limits, the base fiber charge may be less than 25 V, e.g., less than 20 V, less than 15 V, less than 11 V, less than 10 V, less than 7 V, less than 5 V, less than 3 V, less than 1 V, less than 0.5 V, or less than 0.1 V.

In some embodiments, the AM/AV fibers are (slightly) charged, e.g., the AM/AV fibers have an AM/AV charge. The charge, in some cases may be expressed in a voltage drop. For example, the AM/AV fiber charge may be less than 20 V, e.g., less than 15 V, less than 11 V, less than 10 V, less than 7 V, less than 5 V, less than 3 V, less than 1 V, less than 0.5 V, or less than 0.1 V.

In terms of lower limits, the AM/AV fiber charge may be greater than 0.001 V, e.g., greater than 0.01 V, greater than 0.1 V, greater than 0.3 V, greater than 0.5 V, greater than 1 V, greater than 3 V, greater than 5 V, or greater than 10 V. In In some cases, the AM/AV fibers have little or no charge. For example, the composition of the AM/AV fibers may prohibit the fibers from taking/holding a charge.

In some cases, the base fiber charge is less than the AM/AV fiber charge. The difference in charge may be greater than 10%, based on the charge of the base fibers, e.g., greater than 20%, greater than 30%, greater than 50%, greater than 75%, or greater than 100%. In some cases, the AM/AV fibers are not charged and the base fibers are charged. In such a case, the difference in charge is 100%. The inventors have found that the difference in charge surprisingly provides for improvements in filtration efficiency, while not deleteriously affecting AM/AV performance.

In some cases, the charge of the disclosed AM/AV fabrics is equal to or greater than conventional fabrics that comprise AM/AV fibers formed from typical AM/AV polymer compositions.

The AM/AV polymer composition (and the resultant AM/AV fibers) may comprise a supplemental polymer, e.g., (small amounts of) olefin, such as polypropylene or polyethylene or PET. Without being bound by theory, it is posited that the addition of a supplemental polymer to the AM/AV polymer composition may contribute to improvements in processability. For example, the employment of the supplemental polymer may help control “spitting” or interruption of polymer flow during the fiber formation process. In some cases, the AM/AV polymer composition may comprise from 0.01 wt% to 10 wt% supplemental polymer, e.g., from 0.05 wt% to 7 wt%, from 0.1 wt% to 5 wt%, from 0.1 wt% to 3 wt%, or from 0.5 wt% to 2 wt%. In terms of lower limits, the AM/AV polymer composition may comprise greater than 0.01 wt% supplemental polymer, e.g., greater than 0.05 wt%, greater than 0.1 wt%, greater than 0.3 wt%, greater than 0.5 wt%, or greater than 1 wt%. In terms of upper limits, the AM/AV polymer composition may comprise less than 10 wt% supplemental polymer, e.g., less than 8 wt%, less than 7 wt%, less than 5 wt%, less than 3 wt%, or less than 1 wt%.

In some cases, the AM/AV fabric comprises base fibers comprising a polypropylene base polymer. The AM/AV fabric may further comprise AM/AV fibers comprising an AM/AV polymer composition comprising a polyamide AM/AV polymer and an AM/AV compound comprising zinc or copper or a combination thereof along with and an optional supplemental polymer comprising an olefin polymer and an optional charge agent.

The content of the AM/AV fibers and the base fibers in the AM/AV fabric may vary widely. In some cases, the fabric may comprise from 10 wt% to 90 wt% base fibers, based on the total weight of the fabric, e.g., from 25 wt% to 75 wt%, from 35 wt% to 65 wt%, or from 40 wt% to 60 wt%. In terms of lower limits, the fabric may comprise greater than 10 wt% base fibers, e.g., greater than 25 wt%, greater than 35 wt%, or greater than 40 wt%. In terms of upper limits, the fabric may comprise less than 90 wt% base fibers, e.g., less than 75 wt%, less than 65 wt%, or less than 60 wt%.

In some cases, the fabric may comprise from 10 wt% to 90 wt% AM/AV fibers, based on the total weight of the fabric, e.g., from 25 wt% to 75 wt%, from 35 wt% to 65 wt%, or from 40 wt% to 60 wt%. In terms of lower limits, the fabric may comprise greater than 10 wt% b AM/AV fibers, e.g., greater than 25 wt%, greater than 35 wt%, or greater than 40 wt%. In terms of upper limits, the fabric may comprise less than 90 wt% AM/AV fibers, e.g., less than 75 wt%, less than 65 wt%, or less than 60 wt%.

It has been found that, in some embodiments, the basis weight of the fabric affects the performance features. In some cases, the fabric has a basis weight greater than 5 g/m², e.g., greater than 7 g/m², greater than 9 g/m², greater than 10 g/m², greater than 15 g/m², greater than 20 g/m², greater than 25 g/m², greater than 50 g/m², greater than 75 g/m², greater than 100 g/m², or greater than 125 g/m². In terms of upper limits, the fabric may have a basis weight less than 300 g/m², e.g., less than 250 g/m², less than 200 g/m², less than 150 g/m², less than 100 g/m², less than 75 g/m², less than 50 g/m², less than 25 g/m², less than 15 g/m², less than 10 g/m², or less than 8 g/m². Additional basis weight ranges and limits are provided below.

In some embodiments, the described AM/AV fabrics demonstrate antimicrobial and/or antiviral properties. In particular, the antimicrobial and/or antiviral properties may be the result of forming the AM/AV fabrics from the polymer compositions described herein.

The AM/AV fabrics of the present disclosure, in addition to relying on physical filtration properties, also provide AM/AV properties, e.g., pathogen-destroying properties. Stated another way, the disclosed AM/AV fabrics not only protect by limiting pathogen intake, they also destroy pathogens via contact with the AM/AV layer(s) or fibers before the pathogens have a chance to enter or contact the body. The AM/AV properties are made possible, at least in part, by the composition of the fibers that make up the fabric. The fabrics contains a polymer component along with an AM/AV compound, e.g., zinc and/or copper, which in some cases, is embedded in the polymer structure (but may not be a component of a polymerized co-polymer). The presence of the AM/AV compound in the polymers of the fibers provides for the pathogen-destroying properties. As a result, the disclosed items prevent growth or transmission of pathogens from contact that otherwise would allow the pathogen to spread. Importantly, because the AM/AV compound may be embedded in the polymer structure, the AM/AV properties are durable, and are not easily worn or washed away. Thus, the AM/AV fabrics disclosed herein achieve a synergistic combination of AM/AV efficacy and filtration performance (and optionally biocompatibility, e.g. irritation and sensitization, performance). In contrast, conventional configurations that employ no AM/AV compound do not and cannot provide the aforementioned synergistic combination of performance features.

The disclosure also relates to a process for producing an AM/AV fabric. The process comprises the steps of intermingling AM/AV fibers (comprising the AM/AV polymer composition) and base fibers (comprising a base polymer composition) to form a fabric web. The process may further comprise the step of charging the fabric web to form the AM/AV fabric, which optionally has some degree of electrical charge. The AM/AV fabric demonstrates the aforementioned synergistic combination of performance features. The processes are discussed in more detail below.

The employment of a polyamide polymer, in some cases, has been shown to increase overall hydrophilicity and/or hygroscopy of the AM/AV fabrics, which works synergistically with the AM/AV compound to destroy pathogens. For example, it is theorized that a polymer of increased hydrophilicity and/or hygroscopy both may better attract liquid and/or capture media that carry microbials and/or viruses, e.g., from the air, and that the increased moisture content allows the polymer composition and the AM/AV compound to more readily destroy, limit, reduce, or inhibit infection and/or pathogenesis of a microbe or virus.

In some cases, the hydrophilicity and/or hygroscopy is advantageous in applications relating to removal of spilled oil from bodies of water. Polypropylene has been commonly used to remove spilled oil but has limitations in removing low levels of oil from bodies of water. Oil sheen resulting from low levels of oil in water, about 150 ppm or less, is difficult to remove with polypropylene fabrics such as oil absorbent materials made from polypropylene meltblown. The hydrophobic behavior of polypropylene will repel water along with the spilled oil on the surface of the water making it difficult to remove the last remaining amount of oil. The addition of nylon fibers to items used to remove oil will attract water along with oil on its surface as opposed to repelling it allowing a composite or bicomponent item to absorb even low levels of spilled oils in these bodies of water.

The composition of the fibers and fabrics are discussed in more detail herein. And the methods of producing the fibers and fabrics, e.g., spunbonding, spun lace, melt blowing, electrospinning, inter alia, are discussed in more detail herein. Other production processes are contemplated, including textile spinning and weaving.

The basis weight of the AM/AV fabric may vary widely. In one embodiment, the AM/AV fabric has a basis weight from 2 g/m² to 40 g/m², e.g., 5 g/m² to 40 g/m², from 2 g/m² to 30 g/m², from 5 g/m² to 28 g/m², from 5 g/m² to 26 g/m², from 5 g/m² to 25 g/m², from 5 g/m² to 24 g/m², from 5 g/m² to 22 g/m², from 2 g/m² to 15 g/m², 6 g/m² to 30 g/m², from 6 g/m² to 28 g/m², from 6 g/m² to 26 g/m², from 6 g/m² to 24 g/m², from 6 g/m² to 22 g/m², 7 g/m² to 30 g/m², from 7 g/m² to 28 g/m², from 7 g/m² to 26 g/m², from 7 g/m² to 24 g/m², from 7 g/m² to 22 g/m², 8 g/m² to 30 g/m², from 8 g/m² to 28 g/m², from 8 g/m² to 26 g/m², from 8 g/m² to 24 g/m², from 8 g/m² to 22 g/m², 9 g/m² to 30 g/m², from 9 g/m² to 28 g/m², from 9 g/m² to 26 g/m², from 9 g/m² to 24 g/m², from 9 g/m² to 22 g/m², from 15 g/m² to 25 g/m², or from 10 g/m² to 20 g/m².

In terms of lower limits, the basis weight of the AM/AV fabric may be greater than 5 g/m², e.g., greater than 6 g/m², greater than 7 g/m², greater than 8 g/m², greater than 9 g/m², greater than 10 g/m², greater than 20 g/m², greater than 30 g/m², greater than 40 g/m², greater than 60 g/m², greater than 80 g/m², greater than 100 g/m², greater than 120 g/m², greater than 140 g/m² or greater than 180 g/m². In terms of upper limits, the basis weight of the AM/AV fabric may be less than 200 g/m², less than 150 g/m², less than 100 g/m², less than 75 g/m², less than 50 g/m², less than 40 g/m², less than 35 g/m², less than 30 g/m², less than 28 g/m², less than 26 g/m², less than 25 g/m², less than 24 g/m², less than 22 g/m², or less than 20 g/m². In some cases, the basis weight of the AM/AV fabric may be about 8 g/m², about 9 g/m², about 10 g/m², about 11 g/m², about 12 g/m², about 13 g/m², about 14 g/m², about 15 g/m², about 16 g/m², about 17 g/m², about 18 g/m², about 19 g/m², about 20 g/m², about 21 g/m², or about 22 g/m², or a basis weight therebetween.

In some embodiments, the AM/AV fabric comprises a plurality of AM/AV fibers having an average fiber diameter less than 50 microns, e.g., less than 45 microns, less than 40 microns, less than 35 microns, less than 30 microns, less than 25 microns, less than 20 microns, less than 15 microns, less than 10 microns, less than 5 microns, less than 3.5 microns, less than 3 microns, less than 2.5 microns, or less than 2.2 microns. In terms of lower limits, the fibers may have an average fiber diameter greater than 0.5 microns, e.g., greater than 1 micron, greater than 1.5 microns, greater than 2 microns, greater than 2.5 microns, greater than 5 microns, or greater than 10 microns. In terms of ranges, the fibers may have an average fiber diameter from 1 micron to 50 microns, e.g., from 1 micron to 45 microns, from 1 micron to 40 microns, from 1 micron to 35 microns, from 1 micron to 30 microns, from 1 micron to 20 microns, from 1 micron to 15 microns, from 1 micron to 10 microns, from 1 micron to 5 microns, from 1.5 microns to 25 microns, from 1.5 microns to 20 microns, from 1.5 microns to 15 microns, from 1.5 microns to 10 microns, from 0.5 microns to 3.5 microns, from 1 micron to 3 microns, from 1.5 microns to 2.5 microns, from 1.5 microns to 2.2 microns, from 1.5 microns to 5 microns, from 2 microns to 25 microns, from 2 microns to 20 microns, from 2 microns to 15 microns, from 2 microns to 10 microns, from 2 microns to 5 microns, from 2.5 microns to 25 microns, from 2.5 microns to 20 microns, from 2.5 microns to 15 microns, from 2.5 microns to 10 microns, from 2.5 microns to 5 microns, from 5 microns to 45 microns, from 5 microns to 40 microns, from 5 microns to 35 microns, from 5 microns to 30 microns, from 10 microns to 45 microns, from 10 microns to 40 microns, from 10 microns to 35 microns, from 10 microns to 30 microns. In some cases, fibers of this size may be referred to as microfibers.

In some embodiments, the AM/AV fabric comprises a plurality of AM/AV fibers having an average fiber diameter less than 1 micron, e.g., less than 0.9 microns, less than 0.8 microns, less than 0.7 microns, less than 0.6 microns, less than 0.5 microns, less than 0.4 microns, less than 0.3 microns, less than 0.2 microns, less than 0.1 microns, less than 0.05 microns, less than 0.04 microns, or less than 0.03 microns. In terms of lower limits, the average fiber diameter of the fibers may be greater than 1 nanometer, e.g., greater than 10 nanometers, greater than 25 nanometers, or greater than 50 nanometers. In terms of ranges, the average fiber diameter of the may be from 1 nanometer to 1 micron, e.g., from 1 nanometer to 0.9 microns, from 1 nanometer to 0.8 microns, from 1 nanometer to 0.7 microns, from 1 nanometer to 0.6 microns, from 1 nanometer to 0.5 microns, from 1 nanometer to 0.4 microns, from 1 nanometer to 0.3 microns, from 1 nanometer to 0.2 microns, from 1 nanometer to 0.1 microns, from 1 nanometer to 0.05 microns, from 1 nanometer to 0.04 microns, from 1 nanometer to 0.3 microns, from 10 nanometers to 1 micron, from 10 nanometers to 0.9 microns, from 10 nanometers to 0.8 microns, from 10 nanometers to 0.7 microns, from 10 nanometers to 0.6 microns, from 10 nanometers to 0.5 microns, from 10 nanometers to 0.4 microns, from 10 nanometers to 0.3 microns, from 10 nanometers to 0.2 microns, from 10 nanometers to 0.1 microns, from 10 nanometers to 0.05 microns, from 10 nanometers to 0.04 microns, from 10 nanometers to 0.03 microns, from 25 nanometers to 1 micron, from 25 nanometers to 0.9 microns, from 25 nanometers to 0.8 microns, from 25 nanometers to 0.7 microns, from 25 nanometers to 0.6 microns, from 25 nanometers to 0.5 microns, from 25 nanometers to 0.4 microns, from 25 nanometers to 0.3 microns, from 25 nanometers to 0.2 microns, from 25 nanometers to 0.1 microns, from 25 nanometers to 0.05 microns, from 25 nanometers to 0.04 microns, from 25 nanometers to 0.03 microns, from 50 nanometers to 1 micron, from 50 nanometers to 0.9 microns, from 50 nanometers to 0.8 microns, from 50 nanometers to 0.7 microns, from 50 nanometers to 0.6 microns, from 50 nanometers to 0.5 microns, from 50 nanometers to 0.4 microns, from 50 nanometers to 0.3 microns, from 50 nanometers to 0.2 microns, from 50 nanometers to 0.1 microns, from 50 nanometers to 0.05 microns, from 50 nanometers to 0.04 microns, or from 50 nanometers to 0.03 microns. In some cases, fibers of this size may be referred to as nanofibers.

These fiber diameter ranges and limits are applicable to the base fibers as well.

The average fiber diameter of fibers formed from different polymers may differ from one another. For example, olefin fibers may be nanofibers and polyamide fibers may be microfibers.

In some embodiments, the AM/AV fibers or the base fibers have a mean flow pore size ranging from 1 micron to 50 microns, e.g., from 2 microns to 40 microns, from 3 microns to 30 microns, from 4 microns to 20 microns, from 6 microns to 20 microns, from 6 microns to 18 microns, or from 8 microns to 15 microns. In terms of lower limits, the AM/AV fibers or the base fibers may have a mean flow pore size greater than 1 micron, e.g., greater than 2 microns, greater than 3 microns, greater than 4 microns, greater than 5 microns, greater than 6 microns, greater than 7 microns, greater than 8 microns, or greater than 9 microns. In terms of upper limits, the AM/AV fibers or the base fibers may have a mean flow pore size less than 50 microns, e.g., less than 40 microns, less than 35 microns, less than 30 microns, less than 25 microns, less than 20 microns, less than 18 microns, or less than 15 microns.

In some cases, the AM/AV fabric has a thickness ranging from 25 microns to 600 microns, e.g., from 25 microns to 500 microns, from 25 microns to 400 microns, from 35 microns to 300 microns, or from 50 microns to 275 microns. In terms of upper limits, the topsheet layer may have a thickness less than 500 microns, e.g., less than 400 microns, less than 300 microns, or less than 275 microns. In terms of lower limits, the topsheet layer may have a thickness greater than 25 microns, e.g., greater than 35 microns, greater than 50 microns, or greater than 60 microns.

### Physical Characteristics

As noted, the AM/AV fabric may benefit from increased hydrophilicity and/or hygroscopy.

In some cases, the hydrophilicity and/or hygroscopy of the AM/AV fabric may be measured by saturation. In some cases, the hydrophilicity and/or hygroscopy of a given layer of the AM/AV fabric may be measured by the amount of water it can absorb (as a percentage of total weight). In some embodiments, the layer is capable of absorbing greater than 1.5 wt.% water, based on the total weight of the polymer, e.g., greater than 2.0 wt.%, greater than 3.0%, greater than 5.0 wt.%, greater than 7.0 wt.%, greater than 10.0 wt.%. or greater than 25.0 wt.%. In terms of ranges, the hydrophilic and/or hygroscopic polymer may be capable of absorbing water in an amount ranging from 1.5 wt.% to 50.0 wt.%, e.g., from 1.5 wt.% to 14.0 wt.%, from 1.5 wt.% to 9.0 wt.%, from 2.0 wt.% to 8 wt.%, from 2.0 wt.% to 7 w%, from 2.5 wt.% to 7 wt.%, or from 1.5 wt.% to 25.0 wt.%,.

In some cases, the hydrophilicity and/or the hygroscopy of the AM/AV fabric may be measured by the water contact angle of the layer. The water contact angle is the angle formed by the interface of a surface of the layer, e.g., of the topsheet layer. Preferably, the contact angle of the layer is measured while the layer is flat (e.g., substantially flat).

In some embodiments, the AM/AV fabric demonstrates a water contact angle less than 90°, e.g., less than 85°, less than 80°, or less than 75°. In terms of lower limits, the water contact angle of a layer may be greater than 10°, e.g., greater than 20°, greater than 30°, or greater than 40°. In terms of ranges, the water contact angle of a layer may be from 10° to 90°, e.g., from 10° to 85°, from 10° to 80°, from 10° to 75°, from 20° to 90°, from 20° to 85°, from 20° to 80°, from 20° to 75°, from 30° to 90°, from 30° to 85°, from 30° to 80°, from 30° to 75°, from 40° to 90°, from 40° to 85°, from 40° to 80°, or from 40° to 75°.

As noted, the increased hydrophilicity and/or hygroscopy of AM/AV fabric may be the result of a polymer composition from which the layer is formed. The polymer compositions described herein, for example, demonstrate increased hydrophilicity and/or hygroscopy and are therefore particularly suitable for the disclosed AM/AV fabric.

In some embodiments, a polymer may be specially prepared to impart increased hydrophilicity and/or hygroscopy. For example, an increase in hygroscopy may be achieved in the selection and/or modification the polymer. In some embodiments, the polymer may be a common polymer, e.g., a common polyamide, which has been modified to increase hygroscopy. In these embodiments, a functional endgroup modification on the polymer may increase hygroscopy. For example, the polymer may be PA6,6, which has been modified to include a functional endgroup that increases hygroscopy.

### AM/AV Polymer Composition

As noted above, the AM/AV fibers/fabrics of the present disclosure may comprise polymer compositions that beneficially exhibit antimicrobial and/or antiviral properties. For example, the topsheet layer and/or the pad layer, may be made from and/or may comprise an antimicrobial/antiviral polymer composition as described herein.

Polymer compositions suitable for use in the AM/AV fabrics described herein generally comprise a polymer and one or more AM/AV compounds, e.g., metals (e.g., metallic compounds). In some embodiments, the polymer compositions comprise a polymer, zinc (provided to the composition via a zinc compound), and/or phosphorus (provided to the composition via a phosphorus compound). In some embodiments, the polymer compositions comprise a polymer, copper (provided to the composition via a copper compound), and phosphorus (provided to the composition via a phosphorus compound).

The base polymer composition may be similar to the AM/AV polymer composition, but would not comprise the one or more AM/AV compounds. Preferable polymers for the base polymer include olefins, as discussed herein, in particular polypropylene and polyethylene.

Exemplary polymer compositions are disclosed in U.S. Pat. Application No. 17/192,491, filed Mar. 4, 2021, and U.S. Pat. Application No. 17/192,533, filed on Mar. 4, 2021, both of which are incorporated herein by reference.

### Polymer

The polymer compositions comprise a polymer, which, in some embodiments, is a polymer suitable for producing fibers and fabrics. In one embodiment, the polymer composition comprises a polymer in an amount ranging from 50 wt.% to 100 wt.%, e.g., from 50 wt.% to 99.99 wt.%, from 50 wt.% to 99.9 wt.%, from 50 wt.% to 99 wt.% from 55 wt.% to 100 wt.%, from 55 wt.% to 99.99 wt.%, from 55 wt.% to 99.9 wt.%, from 55 wt.% to 99 wt.%, from 60 wt.% to 100 wt.%, from 60 wt.% to 99.99 wt.%, from 60 wt.% to 99.9 wt.%, from 60 wt.% to 99 wt.%., from 65 wt.% to 100 wt.%, from 65 wt.% to 99.99 wt.%, from 65 wt.% to 99.9 wt.%, or from 65 wt.% to 99 wt.%. In terms of upper limits, the polymer composition may comprise less than 100 wt.% of the polymer, e.g., less than 99.99 wt.%, less than 99.9 wt.%, or less than 99 wt.%. In terms of lower limits, the polymer composition may comprise greater than 50 wt.% of the polymer, e.g., greater than 55 wt.%, greater than 60 wt.%, or greater than 65 wt.%.

The polymer of the polymer composition may vary widely. The polymer may include but is not limited to, a thermoplastic polymer, polyester, nylon, rayon, polyamide 6, polyamide 6,6, polyethylene (PE), polypropylene (PP), polyethylene terephthalate (PET), polyethylene terephthalate glycol (PETG), co-PET, polybutylene terephthalate (PBT) polylactic acid (PLA), and polytrimethylene terephthalate (PTT). In some embodiments, the polymer composition may comprise PET, for its strength, longevity during washing, ability to be made permanent press, and ability to be blended with other fibers. In some embodiments, the polymer may be PA6,6. In some cases, nylon is known to be a stronger fiber than PET and exhibits a non-drip burning characteristic that is beneficial, e.g., in military or automotive textile applications, and is more hydrophilic than PET. The polymer used in the present disclosure can be a polyamide, polyether amide, polyether ester or polyether urethane or a mixture thereof.

In some cases, the polymer compositions may comprise polyethylene. Suitable examples of polyethylene include linear low-density polyethylene (LLDPE), low-density polyethylene (LDPE), medium-density polyethylene (MDPE), high-density polyethylene (HDPE), and ultra-high-molecular-weight polyethylene (UHMWPE).

In some cases, the polymer compositions may comprise polycarbonate (PC). For example, the polymer composition may comprise a blend of polycarbonate with other polymers, e.g., a blend of polycarbonate and acrylonitrile butadiene styrene (PC-ABS), a blend of polycarbonate and polyvinyl toluene (PC-PVT), a blend of polycarbonate and polybutylene terephthalate (PC-PBT), a blend of polycarbonate and polyethylene terephthalate (PC-PET), or combinations thereof.

In some cases, the polymer composition may comprise polyamides. Common polyamides include nylons and aramids. For example, the polyamide may comprise PA-4T/4I; PA-4T/6I; PA-5T/5I; PA-6; PA6,6; PA6,6/6; PA6,6/6T; PA-6T/6I; PA-6T/6I/6; PA-6T/6; PA-6T/6I/66; PA-6T/MPMDT (where MPMDT is polyamide based on a mixture of hexamethylene diamine and 2-methylpentamethylene diamine as the diamine component and terephthalic acid as the diacid component); PA-6T/66; PA-6T/610; PA-10T/612; PA-10T/106; PA-6T/612; PA-6T/10T; PA-6T/10I; PA-9T; PA-10T; PA-12T; PA-10T/10I; PA-10T/12; PA-10T/11; PA-6T/9T; PA-6T/12T; PA-6T/10T/6I; PA-6T/6I/6; PA-6T/61/12; and copolymers, blends, mixtures and/or other combinations thereof. Additional suitable polyamides, additives, and other components are disclosed in U.S. Pat. Application No. 16/003,528.

In some embodiments, the polymer compositions comprise a thermoplastic polymer, polyester, nylon, rayon, polyamide, polyamide, poly olefin, polyolefin terephthalate, polyolefin terephthalate glycol, co-PET, or polylactic acid, or combinations thereof.

The polymer composition may, in some embodiments, comprise a combination of polyamides. By combining various polyamides, the final composition may be able to incorporate the desirable properties, e.g., mechanical properties, of each constituent polyamides. For example, in some embodiments, the polyamide comprises a combination of PA-6, PA6,6, and PA6,6/6T. In these embodiments, the polyamide may comprise from 1 wt.% to 99 wt.% PA-6, from 30 wt.% to 99 wt.% PA6,6, and from 1 wt.% to 99 wt.% PA6,6/6T. In some embodiments, the polyamide comprises one or more of PA-6, PA6,6, and PA6,6/6T. In some aspects, the polymer composition comprises 6 wt.% of PA-6 and 94 wt.% of PA6,6. In some aspects, the polymer composition comprises copolymers or blends of any of the polyamides mentioned herein.

In some cases, the AM/AV polymer comprises a polyamide, e.g., PA-66 and/or PA-6 and/or PA-6,12, and/or PA-12, and the base polymer comprise an olefin polymer, e.g., polypropylene.

In addition to the AM/AV polymer, the AM/AV polymer composition may further comprise a supplemental polymer. It has been found that the inclusion of a supplemental polymer (even in small amount), provides for processing advantages, e.g., the elimination of the interruption of fiber formation commonly referred to as “spitting” during the processing of the AM/AV fibers. The supplemental polymer may be a polymer different from the AM/AV polymer. For example, the AM/AV polymer may be a polyamide and the supplemental polymer may be a polyolefin, e.g., polypropylene. In some cases, the supplemental polymer and the base polymer may be the same. In other cases, the supplemental polymer and the base polymer may be different. In some embodiments, the process may be practiced by mixing or blending polypropylene and nylon together in the extruder. The polypropylene may contain additives that help enhance this polymers ability to retain electrical charge. It is contemplated that blending or mixing polypropylene will also reduce the interruption of fiber formation.

The polymer composition may also comprise polyamides produced through the ring-opening polymerization or polycondensation, including the copolymerization and/or copolycondensation, of lactams. Without being bound by theory, these polyamides may include, for example, those produced from propriolactam, butyrolactam, valerolactam, and caprolactam. For example, in some embodiments, the polyamide is a polymer derived from the polymerization of caprolactam. In those embodiments, the polymer comprises at least 10 wt.% caprolactam, e.g., at least 15 wt.%, at least 20 wt.%, at least 25 wt.%, at least 30 wt.%, at least 35 wt.%, at least 40 wt.%, at least 45 wt.%, at least 50 wt.%, at least 55 wt.%, or at least 60 wt.%. In some embodiments, the polymer includes from 10 wt.% to 60 wt.% of caprolactam, e.g., from 15 wt.% to 55 wt.%, from 20 wt.% to 50 wt.%, from 25 wt.% to 45 wt.%, or from 30 wt.% to 40 wt.%. In some embodiments, the polymer comprises less than 60 wt.% caprolactam, e.g., less than 55 wt.%, less than 50 wt.%, less than 45 wt.%, less than 40 wt.%, less than 35 wt.%, less than 30 wt.%, less than 25 wt.%, less than 20 wt.%, or less than 15 wt.%. Furthermore, the polymer composition may comprise the polyamides produced through the copolymerization of a lactam with a nylon, for example, the product of the copolymerization of a caprolactam with PA6,6.

In some aspects, the polymer can formed by conventional polymerization of the polymer composition in which an aqueous solution of at least one diamine-carboxylic acid salt is heated to remove water and effect polymerization to form an antiviral nylon. This aqueous solution is preferably a mixture which includes at least one polyamide-forming salt in combination with the specific amounts of a zinc compound, a copper compound, and/or a phosphorus compound described herein to produce a polymer composition. Conventional polyamide salts are formed by reaction of diamines with dicarboxylic acids with the resulting salt providing the monomer. In some embodiments, a preferred polyamide-forming salt is hexamethylenediamine adipate (nylon 6,6 salt) formed by the reaction of equimolar amounts of hexamethylenediamine and adipic acid.

### AM/AV (Metallic) Compounds

As noted above, the polymer composition may include one or more AM/AV compounds, which may be in the form of a metallic compound. In some embodiments, the polymer composition includes zinc, e.g., in a zinc compound, optionally phosphorus, e.g., in a phosphorus compound, optionally copper, e.g., in a copper compound, optionally silver, e.g., in a silver compound, or combinations thereof. As used herein, a metallic compound refers to a compound having at least one metal molecule or ion, e.g., a “zinc compound” refers to a compound having at least one zinc molecule or ion.

Some conventional polymer compositions, fibers, and fabrics utilize AM/AV compounds to inhibit viruses and other pathogens. For example, some fabrics may include antimicrobial additives, e.g., silver, coated or applied as a film on an exterior surface. However, it has been found that these treatments or coatings often present a host of problems. For example, the coated additives may extract out of the fibers/fabric during dyeing or washing processes, which adversely affects the antimicrobial and/or antiviral properties. As it relates to conventional products, while in constant use, some coatings, e.g., silver, may contribute to health and/or even environmental problems. In contrast to conventional formulations, the polymer compositions disclosed herein comprise a unique combination of AM/AV compounds (e.g., metallic compounds) rather than simply coating the AM/AV compounds on a surface. Stated another way, the polymer composition may have certain amounts of a metallic compound embedded in the polymer matrix such that the polymer composition retains AM/AV properties during and after dyeing and/or washing.

In one embodiment, AM/AV compounds can be added as a masterbatch. The masterbatch may include a polyamide such as nylon 6 or nylon 6,6. Other masterbatch compositions are contemplated.

The polymer composition may comprise metallic compounds, e.g., a metal or a metallic compound, dispersed within the polymer composition. In one embodiment, the polymer composition comprises metallic compounds in an amount ranging from 5 wppm to 20,000 wppm, e.g., from 5 wppm to 17,500 wppm, from 5 wppm to 17,000 wppm, from 5 wppm to 16,500 wppm, from 5 wppm to 16,000 wppm, from 5 wppm to 15,500 wppm, from 5 wppm to 15,000 wppm, from 5 wppm to 12,500 wppm, from 5 wppm to 10,000 wppm, from 5 wppm to 5000 wppm, from 5 wppm to 4000 wppm, e.g., from 5 wppm to 3000 wppm, from 5 wppm to 2000 wppm, from 5 wppm to 1000 wppm, from 5 wppm to 500 wppm, from 10 wppm to 20,000 wppm, from 10 wppm to 17,500 wppm, from 10 wppm to 17,000 wppm, from 10 wppm to 16,500 wppm, from 10 wppm to 16,000 wppm, from 10 wppm to 15,500 wppm, from 10 wppm to 15,000 wppm, from 10 wppm to 12,500 wppm, from 10 wppm to 10,000 wppm, from 10 wppm to 5000 wppm, from 10 wppm to 4000 wppm, from 10 wppm to 3000 wppm, from 10 wppm to 2000 wppm, from 10 wppm to 1000 wppm, from 10 wppm to 500 wppm, from 50 wppm to 20,000 wppm, from 50 wppm to 17,500 wppm, from 50 wppm to 17,000 wppm, from 50 wppm to 16,500 wppm, from 50 wppm to 16,000 wppm, from 50 wppm to 15,500 wppm, from 50 wppm to 15,000 wppm, from 50 wppm to 12,500 wppm, from 50 wppm to 10,000 wppm, from 50 wppm to 5000 wppm, from 50 wppm to 4000 wppm, from 50 wppm to 3000 wppm, from 50 wppm to 2000 wppm, from 50 wppm to 1000 wppm, from 50 wppm to 500 wppm, from 100 wppm to 20,000 wppm, from 100 wppm to 17,500 wppm, from 100 wppm to 17,000 wppm, from 100 wppm to 16,500 wppm, from 100 wppm to 16,000 wppm, from 100 wppm to 15,500 wppm, from 100 wppm to 15,000 wppm, from 100 wppm to 12,500 wppm, from 100 wppm to 10,000 wppm, from 100 wppm to 5000 wppm, from 100 wppm to 4000 wppm, from 100 wppm to 3000 wppm, from 100 wppm to 2000 wppm, from 100 wppm to 1000 wppm, from 100 wppm to 500 wppm, from 200 wppm to 20,000 wppm, from 200 wppm to 17,500 wppm, from 200 wppm to 17,000 wppm, from 200 wppm to 16,500 wppm, from 200 wppm to 16,000 wppm, from 200 wppm to 15,500 wppm, from 200 wppm to 15,000 wppm, from 200 wppm to 12,500 wppm, from 200 wppm to 10,000 wppm, from 200 wppm to 5000 wppm, from 200 wppm to 4000 wppm, from 200 wppm to 3000 wppm, from 200 wppm to 2000 wppm, from 200 wppm to 1000 wppm, or from 200 wppm to 500 wppm.

In terms of lower limits, the polymer composition may comprise greater than 5 wppm metallic compounds, e.g., greater than 10 wppm, greater than 50 wppm, greater than 100 wppm, greater than 200 wppm, or greater than 300 wppm. In terms of upper limits, the polymer composition may comprise less than 20,000 wppm metallic compounds, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, or less than 500 wppm. As noted above, the metallic compounds are preferably embedded in the polymer formed from the polymer composition.

As noted above, the polymer composition includes zinc in a zinc compound and phosphorus in a phosphorus compound, preferably in specific amounts in the polymer composition, to provide the aforementioned structural and antiviral benefits. As used herein, “zinc compound” refers to a compound having at least one zinc molecule or ion (likewise for copper compounds). As used herein, “phosphorus compound” refers to a compound having at least one phosphorus molecule or ion. Zinc content may be indicated by zinc or zinc ion (the same is true for copper). The ranges and limits may be employed for zinc content and for zinc ion content, and for other metal content, e.g., copper content. The calculation of zinc ion content based on zinc or zinc compound can be made by the skilled chemist, and such calculations and adjustments are contemplated.

The inventors have found that the use of specific zinc compounds (and the zinc contained therein) and phosphorus compounds (and the phosphorus contained therein) at specific molar ratios minimizes the negative effects of the zinc compound on the polymer composition. For example, too much zinc compound in the polymer composition can lead to decreased polymer viscosity and inefficiencies in production processes.

The polymer composition may comprise zinc, e.g., in a zinc compound or as zinc ion, e.g., zinc or a zinc compound, dispersed within the polymer composition. In one embodiment, the polymer composition comprises zinc in an amount ranging from 5 wppm to 20,000 wppm, e.g., from 5 wppm to 17,500 wppm, from 5 wppm to 17,000 wppm, from 5 wppm to 16,500 wppm, from 5 wppm to 16,000 wppm, from 5 wppm to 15,500 wppm, from 5 wppm to 15,000wppm, from 5 wppm to 12,500 wppm, from 5 wppm to 10,000 wppm, from 5 wppm to 5000 wppm, from 5 wppm to 4000 wppm, e.g., from 5 wppm to 3000 wppm, from 5 wppm to 2000 wppm, from 5 wppm to 1000 wppm, from 5 wppm to 500 wppm, from 10 wppm to 20,000 wppm, from 10 wppm to 17,500 wppm, from 10 wppm to 17,000 wppm, from 10 wppm to 16,500 wppm, from 10 wppm to 16,000 wppm, from 10 wppm to 15,500 wppm, from 10 wppm to 15,000 wppm, from 10 wppm to 12,500 wppm, from 10 wppm to 10,000 wppm, from 10 wppm to 5000 wppm, from 10 wppm to 4000 wppm, from 10 wppm to 3000 wppm, from 10 wppm to 2000 wppm, from 10 wppm to 1000 wppm, from 10 wppm to 500 wppm, from 50 wppm to 20,000 wppm, from 50 wppm to 17,500 wppm, from 50 wppm to 17,000 wppm, from 50 wppm to 16,500 wppm, from 50 wppm to 16,000 wppm, from 50 wppm to 15,500 wppm, from 50 wppm to 15,000 wppm, from 50 wppm to 12,500 wppm, from 50 wppm to 10,000 wppm, from 50 wppm to 5000 wppm, from 50 wppm to 4000 wppm, from 50 wppm to 3000 wppm, from 50 wppm to 2000 wppm, from 50 wppm to 1000 wppm, from 50 wppm to 500 wppm, from 100 wppm to 20,000 wppm, from 100 wppm to 17,500 wppm, from 100 wppm to 17,000 wppm, from 100 wppm to 16,500 wppm, from 100 wppm to 16,000 wppm, from 100 wppm to 15,500 wppm, from 100 wppm to 15,000 wppm, from 100 wppm to 12,500 wppm, from 100 wppm to 10,000 wppm, from 100 wppm to 5000 wppm, from 100 wppm to 4000 wppm, from 100 wppm to 3000 wppm, from 100 wppm to 2000 wppm, from 100 wppm to 1000 wppm, from 100 wppm to 500 wppm, from 200 wppm to 20,000 wppm, from 200 wppm to 17,500 wppm, from 200 wppm to 17,000 wppm, from 200 wppm to 16,500 wppm, from 200 wppm to 16,000 wppm, from 200 wppm to 15,500 wppm, from 200 wppm to 15,000 wppm, from 200 wppm to 12,500 wppm, from 200 wppm to 10,000 wppm, from 200 wppm to 5000 wppm, from 200 wppm to 4000 wppm, 5000 wppm to 20000 wppm, from 200 wppm to 3000 wppm, from 200 wppm to 2000 wppm, from 200 wppm to 1000 wppm, from 200 wppm to 500 wppm, from 10 wppm to 900 wppm, from 200 wppm to 900 wppm, from 425 wppm to 600 wppm, from 425 wppm to 525 wppm, from 350 wppm to 600 wppm, from 375 wppm to 600 wppm, from 375 wppm to 525 wppm, from 480 wppm to 600 wppm, from 480 wppm to 525 wppm, from 600 wppm to 750 wppm, or from 600 wppm to 700 wppm.

In terms of lower limits, the polymer composition may comprise greater than 5 wppm of zinc, e.g., greater than 10 wppm, greater than 50 wppm, greater than 100 wppm, greater than 200 wppm, greater than 300 wppm, greater than 350 wppm, greater than 375 wppm, greater than 400 wppm, greater than 425 wppm, greater than 480 wppm, greater than 500 wppm, or greater than 600 wppm.

In terms of upper limits, the polymer composition may comprise less than 20,000 wppm of zinc, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, less than 500 wppm, less than 400 wppm, less than 330 wppm, less than 300. In some aspects, the zinc compound is embedded in the polymer formed from the polymer composition.

The ranges and limits are applicable to both zinc in elemental or ionic form and to zinc compound. The same is true for other ranges and limits disclosed herein relating to other metals, e.g., copper. For example, the ranges may relate to the amount of zinc ions dispersed in the polymer.

The zinc of the polymer composition is present in or provided via a zinc compound, which may vary widely. The zinc compound may comprise zinc oxide, zinc ammonium adipate, zinc acetate, zinc ammonium carbonate, zinc stearate, zinc phenyl phosphinic acid, or zinc pyrithione, or combinations thereof. In some embodiments, the zinc compound comprises zinc oxide, zinc ammonium adipate, zinc acetate, or zinc pyrithione, or combinations thereof. In some embodiments, the zinc compound comprises zinc oxide, zinc stearate, or zinc ammonium adipate, or combinations thereof. In some aspects, the zinc is provided in the form of zinc oxide. In some aspects, the zinc is not provided via zinc phenyl phosphinate and/or zinc phenyl phosphonate.

The inventors have also found that the polymer compositions surprisingly may benefit from the use of specific zinc compounds. In particular, the use of zinc compounds prone to forming ionic zinc (e.g., Zn²⁺) may increase the antiviral properties of the polymer composition. It is theorized that the ionic zinc disrupts the replicative cycle of the virus. For example, the ionic zinc may interfere with, e.g., inhibit viral protease or polymerase activity. Further discussion of the effect of ionic zinc on viral activity is found in Velthuis et al., Zn Inhibits Coronavirus and Arterivirus RNA Polymerase Activity In Vitro and Zinc Ionophores Block the Replication of These Viruses in Cell Culture, PLoS Pathogens (November 2010), which is incorporated herein by reference.

The amount of the zinc compound present in the polymer compositions may be discussed in relation to the ionic zinc content. In one embodiment, the polymer composition comprises ionic zinc, e.g., Zn²⁺, in an amount ranging from 1 wppm to 30,000 wppm, e.g., from 1 wppm to 25,000 wppm, from 1 wppm to 20,000 wppm, from 1 wppm to 15,000 wppm, from 1 wppm to 10,000 wppm, from 1 wppm to 5,000 wppm, from 1 wppm to 2,500 wppm, from 50 wppm to 30,000 wppm, from 50 wppm to 25,000 wppm, from 50 wppm to 20,000 wppm, from 50 wppm to 15,000 wppm, from 50 wppm to 10,000 wppm, from 50 wppm to 5,000 wppm, from 50 wppm to 2,500 wppm, from 100 wppm to 30,000 wppm, from 100 wppm to 25,000 wppm, from 100 wppm to 20,000 wppm, from 100 wppm to 15,000 wppm, from 100 wppm to 10,000 wppm, from 100 wppm to 5,000 wppm, from 100 wppm to 2,500 wppm, from 150 wppm to 30,000 wppm, from 150 wppm to 25,000 wppm, from 150 wppm to 20,000 wppm, from 150 wppm to 15,000 wppm, from 150 wppm to 10,000 wppm, from 150 wppm to 5,000 wppm, from 150 wppm to 2,500 wppm, from 250 wppm to 30,000 wppm, from 250 wppm to 25,000 wppm, from 250 wppm to 20,000 wppm, from 250 wppm to 15,000 wppm, from 250 wppm to 10,000 wppm, from 250 wppm to 5,000 wppm, or from 250 wppm to 2,500 wppm. In some cases, the ranges and limits mentioned above for zinc may also be applicable to ionic zinc content.

In some cases, the use of zinc provides for processing and or end use benefits. Other antiviral agents, e.g., copper or silver, may be used, but these often include adverse effects (e.g., on the relative viscosity of the polymer composition, toxicity, and health or environmental risk). In some situations, the zinc does not have adverse effects on the relative viscosity of the polymer composition. Also, the zinc, unlike other antiviral agents, e.g., silver, does not present toxicity issues (and in fact may provide health advantages, such as immune system support). In addition, as noted herein, the use of zinc provides for the reduction or elimination of leaching into other media and/or into the environment. This both prevents the risks associated with introducing zinc into the environment and allows the polymer composition to be reused - zinc provides surprising “green” advantages over conventional, e.g., silver-containing, compositions.

As noted above, the polymer composition, in some embodiments, includes copper (provided via a copper compound). As used herein, “copper compound” refers to a compound having at least one copper molecule or ion. In some embodiments, the AM/AV compound comprises zinc and/or copper.

In some cases, the copper compound may improve, e.g., enhance the antiviral properties of the polymer composition. In some cases, the copper compound may affect other characteristics of the polymer composition, e.g., antimicrobial activity or physical characteristics.

The polymer composition may comprise copper (e.g., in a copper compound), e.g., copper or a copper compound, dispersed within the polymer composition. In one embodiment, the polymer composition comprises copper in an amount ranging from 5 wppm to 20,000 wppm, e.g., from 5 wppm to 17,500 wppm, from 5 wppm to 17,000 wppm, from 5 wppm to 16,500 wppm, from 5 wppm to 16,000 wppm, from 5 wppm to 15,500 wppm, from 5 wppm to 15,000 wppm, from 5 wppm to 12,500 wppm, from 5 wppm to 10,000 wppm, from 5 wppm to 5000 wppm, from 5 wppm to 4000 wppm, e.g., from 5 wppm to 3000 wppm, from 5 wppm to 2000 wppm, from 5 wppm to 1000 wppm, from 5 wppm to 500 wppm, from 5 wppm to 100 wppm, from 5 wppm to 50 wppm, from 5 wppm to 35 wppm, from 10 wppm to 20,000 wppm, from 10 wppm to 17,500 wppm, from 10 wppm to 17,000 wppm, from 10 wppm to 16,500 wppm, from 10 wppm to 16,000 wppm, from 10 wppm to 15,500 wppm, from 10 wppm to 15,000 wppm, from 10 wppm to 12,500 wppm, from 10 wppm to 10,000 wppm, from 10 wppm to 5000 wppm, from 10 wppm to 4000 wppm, from 10 wppm to 3000 wppm, from 10 wppm to 2000 wppm, from 10 wppm to 1000 wppm, from 10 wppm to 500 wppm, from 50 wppm to 20,000 wppm, from 50 wppm to 17,500 wppm, from 50 wppm to 17,000 wppm, from 50 wppm to 16,500 wppm, from 50 wppm to 16,000 wppm, from 50 wppm to 15,500 wppm, from 50 wppm to 15,000 wppm, from 50 wppm to 12,500 wppm, from 50 wppm to 10,000 wppm, from 50 wppm to 5000 wppm, from 50 wppm to 4000 wppm, from 50 wppm to 3000 wppm, from 50 wppm to 2000 wppm, from 50 wppm to 1000 wppm, from 50 wppm to 500 wppm, from 100 wppm to 20,000 wppm, from 100 wppm to 17,500 wppm, from 100 wppm to 17,000 wppm, from 100 wppm to 16,500 wppm, from 100 wppm to 16,000 wppm, from 100 wppm to 15,500 wppm, from 100 wppm to 15,000 wppm, from 100 wppm to 12,500 wppm, from 100 wppm to 10,000 wppm, from 100 wppm to 5000 wppm, from 100 wppm to 4000 wppm, from 100 wppm to 3000 wppm, from 100 wppm to 2000 wppm, from 100 wppm to 1000 wppm, from 100 wppm to 500 wppm, from 200 wppm to 20,000 wppm, from 200 wppm to 17,500 wppm, from 200 wppm to 17,000 wppm, from 200 wppm to 16,500 wppm, from 200 wppm to 16,000 wppm, from 200 wppm to 15,500 wppm, from 200 wppm to 15,000 wppm, from 200 wppm to 12,500 wppm, from 200 wppm to 10,000 wppm, from 200 wppm to 5000 wppm, from 200 wppm to 4000 wppm, from 200 wppm to 3000 wppm, from 200 wppm to 2000 wppm, from 200 wppm to 1000 wppm, or from 200 wppm to 500 wppm.

In terms of lower limits, the polymer composition may comprise greater than 5 wppm of copper, e.g., greater than 10 wppm, greater than 50 wppm, greater than 100 wppm, greater than 200 wppm, or greater than 300 wppm. In terms of upper limits, the polymer composition may comprise less than 20,000 wppm of copper, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, less than 500 wppm less than 100 wppm, less than 50 wppm, less than 35 wppm. In some aspects, the copper compound is embedded in the polymer formed from the polymer composition.

The composition of the copper compound is not particularly limited. Suitable copper compounds include copper iodide, copper bromide, copper chloride, copper fluoride, copper oxide, copper stearate, copper ammonium adipate, copper acetate, or copper pyrithione, or combinations thereof. The copper compound may comprise copper oxide, copper ammonium adipate, copper acetate, copper ammonium carbonate, copper stearate, copper phenyl phosphinic acid, or copper pyrithione, or combinations thereof. In some embodiments, the copper compound comprises copper oxide, copper ammonium adipate, copper acetate, or copper pyrithione, or combinations thereof. In some embodiments, the copper compound comprises copper oxide, copper stearate, or copper ammonium adipate, or combinations thereof. In some aspects, the copper is provided in the form of copper oxide. In some aspects, the copper is not provided via copper phenyl phosphinate and/or copper phenyl phosphonate.

In some cases, the polymer composition includes silver (optionally provided via a silver compound). As used herein, “silver compound” refers to a compound having at least one silver molecule or ion. The silver may be in ionic form. The ranges and limits for silver may be similar to the ranges and limits for copper (discussed above).

In one embodiment, the molar ratio of the copper to the zinc is greater than 0.01:1, e.g., greater than 0.05:1, greater than 0.1:1, greater than 0.15:1, greater than 0.25:1, greater than 0.5:1, or greater than 0.75:1. In terms of ranges, the molar ratio of the copper to the zinc in the polymer composition may range from 0.01:1 to 15:1, e.g., from 0.05:1 to 10:1, from 0.1:1 to 9:1, from 0.15:1 to 8:1, from 0.25:1 to 7:1, from 0.5:1 to 6:1, from 0.75:1 to 5:1 from 0.5:1 to 4:1, or from 0.5:1 to 3:1. In terms of upper limits, the molar ratio of zinc to copper in the polymer composition may be less than 15:1, e.g., less than 10:1, less than 9:1, less than 8:1, less than 7:1, less than 6:1, less than 5:1, less than 4:1, or less than 3:1. In some cases, copper is bound in the polymer matrix along with zinc.

In some embodiments, the use of cuprous ammonium adipate has been found to be particularly effective in activating copper ions into the polymer matrix. Similarly, the use of silver ammonium adipate has been found to be particularly effective in activating silver ions into the polymer matrix. It is found that dissolving copper (I) or copper (II) compounds in ammonium adipate is particularly efficient at generating copper (I) or copper (II) ions. The same is true for dissolving Ag (I) or Ag (III) compounds in ammonium adipate to generate Ag1+ or Ag3+ ions.

The polymer composition may comprise silver (e.g., in a silver compound), e.g., silver or a silver compound, dispersed within the polymer composition. In one embodiment, the polymer composition comprises silver in an amount ranging from 5 wppm to 20,000 wppm, e.g., from 5 wppm to 17,500 wppm, from 5 wppm to 17,000 wppm, from 5 wppm to 16,500 wppm, from 5 wppm to 16,000 wppm, from 5 wppm to 15,500 wppm, from 5 wppm to 15,000 wppm, from 5 wppm to 12,500 wppm, from 5 wppm to 10,000 wppm, from 5 wppm to 5000 wppm, from 5 wppm to 4000 wppm, e.g., from 5 wppm to 3000 wppm, from 5 wppm to 2000 wppm, from 5 wppm to 1000 wppm, from 5 wppm to 500 wppm, from 10 wppm to 20,000 wppm, from 10 wppm to 17,500 wppm, from 10 wppm to 17,000 wppm, from 10 wppm to 16,500 wppm, from 10 wppm to 16,000 wppm, from 10 wppm to 15,500 wppm, from 10 wppm to 15,000 wppm, from 10 wppm to 12,500 wppm, from 10 wppm to 10,000 wppm, from 10 wppm to 5000 wppm, from 10 wppm to 4000 wppm, from 10 wppm to 3000 wppm, from 10 wppm to 2000 wppm, from 10 wppm to 1000 wppm, from 10 wppm to 500 wppm, from 50 wppm to 20,000 wppm, from 50 wppm to 17,500 wppm, from 50 wppm to 17,000 wppm, from 50 wppm to 16,500 wppm, from 50 wppm to 16,000 wppm, from 50 wppm to 15,500 wppm, from 50 wppm to 15,000 wppm, from 50 wppm to 12,500 wppm, from 50 wppm to 10,000 wppm, from 50 wppm to 5000 wppm, from 50 wppm to 4000 wppm, from 50 wppm to 3000 wppm, from 50 wppm to 2000 wppm, from 50 wppm to 1000 wppm, from 50 wppm to 500 wppm, from 100 wppm to 20,000 wppm, from 100 wppm to 17,500 wppm, from 100 wppm to 17,000 wppm, from 100 wppm to 16,500 wppm, from 100 wppm to 16,000 wppm, from 100 wppm to 15,500 wppm, from 100 wppm to 15,000 wppm, from 100 wppm to 12,500 wppm, from 100 wppm to 10,000 wppm, from 100 wppm to 5000 wppm, from 100 wppm to 4000 wppm, from 100 wppm to 3000 wppm, from 100 wppm to 2000 wppm, from 100 wppm to 1000 wppm, from 100 wppm to 500 wppm, from 200 wppm to 20,000 wppm, from 200 wppm to 17,500 wppm, from 200 wppm to 17,000 wppm, from 200 wppm to 16,500 wppm, from 200 wppm to 16,000 wppm, from 200 wppm to 15,500 wppm, from 200 wppm to 15,000 wppm, from 200 wppm to 12,500 wppm, from 200 wppm to 10,000 wppm, from 200 wppm to 5000 wppm, from 200 wppm to 4000 wppm, from 200 wppm to 3000 wppm, from 200 wppm to 2000 wppm, from 200 wppm to 1000 wppm, or from 200 wppm to 500 wppm.

In terms of lower limits, the polymer composition may comprise greater than 5 wppm of silver, e.g., greater than 10 wppm, greater than 50 wppm, greater than 100 wppm, greater than 200 wppm, or greater than 300 wppm. In terms of upper limits, the polymer composition may comprise less than 20,000 wppm of silver, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, or less than 500 wppm. In some aspects, the silver compound is embedded in the polymer formed from the polymer composition.

The composition of the silver compound is not particularly limited. Suitable silver compounds include silver iodide, silver bromide, silver chloride, silver fluoride, silver oxide, silver stearate, silver ammonium adipate, silver acetate, or silver pyrithione, or combinations thereof. The silver compound may comprise silver oxide, silver ammonium adipate, silver acetate, silver ammonium carbonate, silver stearate, silver phenyl phosphinic acid, or silver pyrithione, or combinations thereof. In some embodiments, the silver compound comprises silver oxide, silver ammonium adipate, silver acetate, or silver pyrithione, or combinations thereof. In some embodiments, the silver compound comprises silver oxide, silver stearate, or silver ammonium adipate, or combinations thereof. In some aspects, the silver is provided in the form of silver oxide. In some aspects, the silver is not provided via silver phenyl phosphinate and/or silver phenyl phosphonate. In some aspects, the silver is provided by dissolving one or more silver compounds in ammonium adipate.

The polymer composition may comprise phosphorus (in a phosphorus compound), e.g., phosphorus or a phosphorus compound is dispersed within the polymer composition. In one embodiment, the polymer composition comprises phosphorus in an amount ranging from 50 wppm to 10000 wppm, e.g., from 50 wppm to 5000 wppm, from 50 wppm to 2500 wppm, from 50 wppm to 2000 wppm, from 50 wppm to 800 wppm, 100 wppm to 750 wppm, 100 wppm to 1800 wppm, from 100 wppm to 10000 wppm, from 100 wppm to 5000 wppm, from 100 wppm to 2500 wppm, from 100 wppm to 1000 wppm, from 100 wppm to 800 wppm, from 200 wppm to 10000 wppm, 200 wppm to 5000 wppm, from 200 wppm to 2500 wppm, from 200 wppm to 800 wppm, from 300 wppm to 10000 wppm, from 300 wppm to 5000 wppm, from 300 wppm to 2500 wppm, from 300 wppm to 500 wppm, from 500 wppm to 10000 wppm, from 500 wppm to 5000 wppm, or from 500 wppm to 2500 wppm. In terms of lower limits, the polymer composition may comprise greater than 50 wppm of phosphorus, e.g., greater than 75 wppm, greater than 100 wppm, greater than 150 wppm, greater than 200 wppm greater than 300 wppm or greater than 500 wppm. In terms of upper limits, the polymer composition may comprise less than 10000 wppm (or 1 wt.%), e.g., less than 5000 wppm, less than 2500 wppm, less than 2000 wppm, less than 1800 wppm, less than 1500 wppm, less than 1000 wppm, less than 800 wppm, less than 750 wppm, less than 500 wppm, less than 475 wppm, less than 450 wppm, less than 400 wppm, less than 350 wppm, less than 300 wppm, less than 250 wppm, less than 200 wppm, less than 150 wppm, less than 100 wppm, less than 50 wppm, less than 25 wppm, or less than 10 wppm.

In some aspects, the phosphorus or the phosphorus compound is embedded in the polymer formed from the polymer composition. As noted above, because of the overall make-up of the disclosed composition low amounts, if any, phosphorus may be employed, which in some cases may provide for advantageous performance results (see above).

The phosphorus of the polymer composition is present in or provided via a phosphorus compound, which may vary widely. The phosphorus compound may comprise bezene phosphinic acid, diphenylphosphinic acid, sodium phenylphosphinate, phosphorous acid, benzene phosphonic acid, calcium phenylphosphinate, potassium B-pentylphosphinate, methylphosphinic acid, manganese hypophosphite, sodium hypophosphite, monosodium phosphate, hypophosphorous acid, dimethylphosphinic acid, ethylphosphinic acid, diethylphosphinic acid, magnesium ethylphosphinate, triphenyl phosphite, diphenylrnethyl phosphite, dimethylphenyl phosphite, ethyldiphenyl phosphite, phenylphosphonic acid, methylphosphonic acid, ethylphosphonic acid, potassium phenylphosphonate, sodium methylphosphonate, calcium ethylphosphonate, and combinations thereof. In some embodiments, the phosphorus compound comprises phosphoric acid, benzene phosphinic acid, or benzene phosphonic acid, or combinations thereof. In some embodiments, the phosphorus compound comprises benzene phosphinic acid, phosphorous acid, or manganese hypophosphite, or combinations thereof. In some aspects, the phosphorus compound may comprise benzene phosphinic acid.

In one embodiment, the molar ratio of the phosphorus to the zinc is greater than 0.01:1, e.g., greater than 0.05:1, greater than 0.1:1, greater than 0.15:1, greater than 0.25:1, greater than 0.5:1, or greater than 0.75:1. In terms of ranges, the molar ratio of the phosphorus to the zinc in the polymer composition may range from 0.01:1 to 15:1, e.g., from 0.05:1 to 10:1, from 0.1:1 to 9:1, from 0.15:1 to 8:1, from 0.25:1 to 7:1, from 0.5:1 to 6:1, from 0.75:1 to 5:1 from 0.5:1 to 4:1, or from 0.5:1 to 3:1. In terms of upper limits, the molar ratio of zinc to phosphorus in the polymer composition may be less than 15:1, e.g., less than 10:1, less than 9:1, less than 8:1, less than 7:1, less than 6:1, less than 5:1, less than 4:1, or less than 3:1. In some cases, phosphorus is bound in the polymer matrix along with zinc.

In one embodiment, the weight ratio of zinc to phosphorus in the polyamide composition may be greater than 1.3:1, e.g., greater than 1.4:1, greater than 1.5:1, greater than 1.6:1, greater than 1.7:1, greater than 1.8:1, or greater than 2:1. In terms of ranges, the weight ratio of zinc to phosphorus in the polyamide composition may range from 1.3:1 to 30:1, e.g., from 1.4:1 to 25:1, from 1.5:1 to 20:1, from 1.6:1 to 15:1, from 1.8:1 to 10:1, from 2:1 to 8:1, from 3:1 to 7:1, or from 4:1 to 6:1. In terms of upper limits, the weight ratio of zinc to phosphorus in the polyamide composition may be less than 30:1, e.g., less than 28:1, less than 26:1, less than 24:1, less than 22:1, less than 20:1, or less than 15:1. In some aspects, there is no phosphorus in the polyamide composition. In other aspects, a very low amount of phosphorus is present. In some cases, phosphorus is held in the polymer matrix along with zinc.

In one embodiment, the weight ratio of zinc to phosphorus in the polyamide composition may be less than 0.64:1, e.g., less than 0.62:1, less than 0.6:1, e.g., less than 0.5:1, less than 0.45:1, less than 0.4:1, less than 0.3:1, or less than 0.25:1. In terms of ranges, the weight ratio of zinc to phosphorus in the polyamide composition may range from 0.001:1 to 0.64:1, e.g., from 0.01:1 to 0.6:1, from 0.05:1 to 0.5:1, from 0.1:1 to 0.45:1, from 0.2:1 to 0.4:1, from 0.25:1 to 0.35:1, or from 0.2:1 to 0.3:1. In terms of lower limits, the weight ratio of zinc to phosphorus in the polyamide composition may be greater than 0.001:1, e.g., greater than 0.005:1, greater than 0.01:1, greater than 0.05:1, greater than 0.1:1, greater than 0.15:1, or greater than 0.2:1.

In some cases, the AM/AV polymer composition further comprises a charge agent, which beneficially improves that ability of the AM/AV fibers to take/hold an electric charge. The charge agent, in some cases may comprise a stearate, e.g., magnesium stearate, and/or a wax.

In some embodiment, the AM/AV polymer composition comprises from 0.01 wt% to 10 wt% charge agent, e.g., from 0.05 wt% to 7 wt%, from 0.1 wt% to 5 wt%, from 0.1 wt% to 3 wt%, from 4% to 10%, from 1 wt% to 5 wt%, or from 0.5 wt% to 2 wt%. In terms of lower limits, the AM/AV polymer composition may comprise greater than 0.01 wt% charge agent, e.g., greater than 0.05 wt%, greater than 0.1 wt%, greater than 0.3 wt%, greater than 0.5 wt%, or greater than 1 wt%. In terms of upper limits, the AM/AV polymer composition may comprise less than 10 wt% charge agent, e.g., less than 8 wt%, less than 7 wt%, less than 5 wt%, less than 3 wt%, or less than 1 wt%.

In some embodiment, the AM/AV polymer composition comprises from 0.01 wt% to 10 wt% wax, e.g., from 0.05 wt% to 7 wt%, from 0.1 wt% to 5 wt%, from 0.1 wt% to 3 wt%, from 0.5 wt% to 2 wt%, from 1 wt% to 5 wt% or from 4% to 10% . In terms of lower limits, the AM/AV polymer composition may comprise greater than 0.01 wt% wax, e.g., greater than 0.05 wt%, greater than 0.1 wt%, greater than 0.3 wt%, greater than 0.5 wt%, or greater than 1 wt%. In terms of upper limits, the AM/AV polymer composition may comprise less than 10 wt% wax, e.g., less than 8 wt%, less than 7 wt%, less than 5 wt%, less than 3 wt%, or less than 1 wt%.

In some cases, the base polymer composition may comprise the charge agent in the amounts discussed with respect to the AM/AV polymer composition.

Advantageously, it has been discovered that adding the above identified zinc compounds and phosphorus compounds may result in a beneficial relative viscosity (RV) of the polymer composition. In some embodiments, the RV of the polymer composition ranges from 2 to 150, e.g., from 3 to 100, from 5 to 80, from 5 to 70, from 10 to 70, from 15 to 65, from 20 to 60, from 30 to 50, from 10 to 35, from 10 to 20, from 5 to 35, from 15 to 30, from 60 to 70, from 50 to 80, from 40 to 50, from 20 to 90, from 25 to 80, from 30 to 60, from 5 to 30, or from 15 to 32. In terms of lower limits, the RV of the polymer composition may be greater than 3, e.g., greater than 5, greater than 10, greater than 15, greater than 20, greater than 25, greater than 27.5, greater than 30, greater than 35, greater than 40, greater than 50, greater than 60, or greater than 70. In terms of upper limits, the RV of the polymer composition may be less than 150, e.g., less than 100, less than 90, less than 80, less than 75, less than 65, less than 60, less than 50, less than 40, or less than 35.

To calculate RV, a polymer is dissolved in a solvent (usually formic or sulfuric acid), the viscosity is measured, then the viscosity is compared to the viscosity of the pure solvent. This give a unitless measurement. Solid fabrics, as well as liquids, may have a specific RV. The fibers/fabrics produced from the polymer compositions may have the aforementioned relative viscosities, as well.

It has been determined that a specific amount of the zinc compound and the phosphorus compound can be mixed in a polymer composition, e.g., polyamide composition, in finely divided form, such as in the form of granules, flakes and the like, to provide a polymer composition that can be subsequently formed, e.g., extruded, molded or otherwise drawn, into various products (e.g., high-contact products, surtopsheet layers of high-contact products) by conventional methods to produce products having substantially improved antimicrobial activity. The zinc and phosphorus are employed in the polymer composition in the aforementioned amounts to provide a fiber with improved antimicrobial activity retention (near-permanent).

### Additional Components

In some embodiments, the polymer composition may comprise additional additives. The additives include pigments, hydrophilic or hydrophobic additives, anti-odor additives, additional antiviral agents, and antimicrobial/anti-fungal inorganic compounds, such as copper, zinc, tin, and silver.

In some embodiments, the polymer composition can be combined with color pigments for coloration for the use in fabrics or other components formed from the polymer composition. In some aspects, the polymer composition can be combined with UV additives to withstand fading and degradation in fabrics exposed to significant UV light. In some aspects, the polymer composition can be combined with additives to make the surface of the fiber hydrophilic or hydrophobic. In some aspects, the polymer composition can be combined with a hygroscopic fabric, e.g., to make the fiber, fabric, or other products formed therefrom more hygroscopic. In some aspects, the polymer composition can be combined with additives to make the fabric flame retardant or flame resistant. In some aspects, the polymer composition can be combined with additives to make the fabric stain resistant. In some aspects, the polymer composition can be combined with pigments with the antimicrobial compounds so that the need for conventional dyeing and disposal of dye fabrics is avoided.

In some embodiments, the polymer composition may further comprise additional additives. For example, the polymer composition may comprise a delusterant. A delusterant additive may improve the appearance and/or texture of the synthetic fibers and fabric produced from the polymer composition. In some embodiments, inorganic pigment-like fabrics can be utilized as delusterants. The delusterants may comprise one or more of titanium dioxide, barium sulfate, barium titanate, zinc titanate, magnesium titanate, calcium titanate, zinc oxide, zinc sulfide, lithopone, zirconium dioxide, calcium sulfate, barium sulfate, aluminum oxide, thorium oxide, magnesium oxide, silicon dioxide, talc, mica, and the like. In preferred embodiments, the delusterant comprises titanium dioxide. It has been found that the polymer compositions that include delusterants comprising titanium dioxide produce synthetic fibers and fabrics that greatly resemble natural fibers and fabrics, e.g., synthetic fibers and fabrics with improved appearance and/or texture. It is believed that titanium dioxide improves appearance and/or texture by interacting with the zinc compound, the phosphorus compound, and/or functional groups within the polymer.

In one embodiment, the polymer composition comprises the delusterant in an amount ranging from 0.0001 wt.% to 3 wt.%, e.g., 0.0001 wt.% to 2 wt.%, from 0.0001 to 1.75 wt.%, from 0.001 wt.% to 3 wt.%, from 0.001 wt.% to 2 wt.%, from 0.001 wt.% to 1.75 wt.%, from 0.002 wt.% to 3 wt.%, from 0.002 wt.% to 2 wt.%, from 0.002 wt.% to 1.75 wt.%, from 0.005 wt.% to 3 wt.%, from 0.005 wt.% to 2 wt.%, from 0.005 wt.% to 1.75 wt.%. In terms of upper limits, the polymer composition may comprise less than 3 wt.% delusterant, e.g., less than 2.5 wt.%, less than 2 wt.% or less than 1.75 wt.%. In terms of lower limits, the polymer composition may comprise greater than 0.0001 wt.% delusterant, e.g., greater than 0.001 wt.%, greater than 0.002 wt.%, or greater than 0.005 wt.%.

In some embodiments, the polymer composition may further comprise colored fabrics, such as carbon black, copper phthalocyanine pigment, lead chromate, iron oxide, chromium oxide, and ultramarine blue.

In some embodiments, the polymer composition may include additional antiviral agents other than zinc. The additional antimicrobial agents may be any suitable antiviral. Conventional antiviral agents are known in the art and may be incorporated in the polymer composition as the additional antiviral agent or agents. For example, the additional antiviral agent may be an entry inhibitor, a reverse transcriptase inhibitor, a DNA polymerase inhibitor, an m-RNA synthesis inhibitor, a protease inhibitor, an integrase inhibitor, or an immunomodulator, or combinations thereof. In some aspects, the additional antimicrobial agent or agents are added to the polymer composition.

In some embodiments, the polymer composition may include additional antimicrobial agents other than zinc. The additional antimicrobial agents may be any suitable antimicrobial, such as silver, copper, and/or gold in metallic forms (e.g., particulates, alloys and oxides), salts (e.g., sulfates, nitrates, acetates, citrates, and chlorides) and/or in ionic forms. In some aspects, further additives, e.g., additional antimicrobial agents, are added to the polymer composition.

In some embodiments, the polymer composition (and the fibers or fabric formed therefrom) may further comprise an antimicrobial or antiviral coating. For example, a fiber or fabric formed from the polymer composition may include a coating of zinc nanoparticles (e.g., nanoparticles of zinc oxide, zinc ammonium adipate, zinc acetate, zinc ammonium carbonate, zinc stearate, zinc phenyl phosphinic acid, or zinc pyrithione, or combinations thereof). To produce such a coating, the surface of polymer composition (e.g., the surface of the fiber and/or fabric formed therefrom) may be cationized and coated layer-by layer by stepwise dipping the polymer composition into an anionic polyelectrolyte solution (e.g., comprising poly 4-styrenesulfonic acid) and a solution comprising the zinc nanoparticles. Optionally, the coated polymer composition may be hydrothermally treated in a solution of NH₄OH at 9° C. for 24 h to immobilize the zinc nanoparticles.

In some cases, the AM/AV fabrics described herein do not require the use or inclusion of acids, e.g., citric acid, and/or acid treatment to be effective. Such treatments are known to create static charge/static decay issues. Advantageously, the elimination of the need for acid treatment, thus eliminates the static charge/static decay issues associated with conventional configurations.

As used herein, “greater than” and “less than” limits may also include the number associated therewith. Stated another way, “greater than” and “less than” may be interpreted as “greater than or equal to” and “less than or equal to.” It is contemplated that this language may be subsequently modified in the claims to include “or equal to.” For example, “greater than 4.0” may be interpreted as, and subsequently modified in the claims as “greater than or equal to 4.0.”

In some embodiments, any or some of the components disclosed herein may be considered optional. In some cases, the disclosed compositions may expressly exclude any or some of the aforementioned additives in this description, e.g., via claim language. For example claim language may be modified to recite that the disclosed compositions, fabrics processes, etc., do not utilize or comprise one or more of the aforementioned additives, e.g., the disclosed fabrics do not comprise a flame retardant or a delusterant. As another example, the claim language may be modified to recite that the disclosed fabrics do not comprise long chain polyamide component, e.g., PA-12.

### Performance Characteristics

The performance of the AM/AV fabric described herein may be assessed using a variety of conventional metrics.

In some cases, the AM/AV performance relates to antifungal performance. The antifungal activity of the AM/AV fabrics may be measured by the standard procedure defined by Mod. E3160. In one embodiment, the AM/AV fabrics inhibits the growth (growth reduction) of Candida auris or candida albicans in an amount greater than 10% fungal growth, e.g., greater than 20%, greater than 30%, greater than 40%, greater than 50%, greater than 60%, greater than 70%, greater than 80%, greater than 90% or greater than 93%.

Bacterial filtration efficiency (or “BFE”) measures how well the AM/AV fabric traps or isolates bacteria when exposed to a bacteria-containing aerosol. BFE measures a percentage of bacteria that trapped or isolated by the AM/AV fabric. ASTM International specifies testing with a droplet size of 3.0 microns containing Staph. aureus (average size 0.6-0.8 microns).

In some embodiments, the AM/AV fabric demonstrates a BFE greater than 90%, e.g., greater than 92%, greater than 93%, greater than 94%, greater than 95%, greater than 97%, greater than 98%, greater than 99%, greater than 99.5%, greater than 99.9%, or greater than 99.99%. In terms upper limits, the AM/AV fabric may demonstrate a BFE less than 100%, e.g., less than 99.999%, less than 99.995%, less than 99.99%, or less than 99.95%.

In some embodiments, the AM/AV fabric demonstrates a BFE of about 90%, about 91%, about 92%, about 93%, about 94%, about 95%, about 95.5%, about 96%, about 96.5%, about 97%, about 97.5%, about 98%, about 98.5%, about 99%, about 99.2%, about 99.3%, about 99.4%, about 99.5%, about 99.8%, about 99.9%, about 99.95%, or about 99.99%, or any percentage therebetween.

In some embodiments, the AM/AV fabric demonstrates a particle filtration efficiency greater than 35%, e.g., greater than 40%, greater than 45%, greater than 50%, greater than 60%, greater than 70%, greater than 80%, or greater than 90%. The particle filtration efficiency may be determined via ASTM F2299 (current year)

In some embodiments, the AM/AV fabric demonstrates an ATI filtration efficiency greater than 12% (at a flow rate of 85 1pm), e.g., greater than 20%, greater than 25%, greater than 30%, greater than 35%, 40%, greater than 45%, greater than 50%, greater than 60%, greater than 70%, greater than 80%, or greater than 90%. The ATI filtration efficiency may be determined via NIOSH Standard Title 42 CFR part 84.

In some embodiments, the AM/AV fabric demonstrates an ATI filtration efficiency greater than 20% (at a flow rate of 60 1pm), e.g., greater than 25%, greater than 30%, greater than 35%, 40%, greater than 45%, greater than 50%, greater than 60%, greater than 70%, greater than 80%, or greater than 90%.

In some embodiments, the AM/AV fabric demonstrates an ATI filtration resistance less than 30% (at a flow rate of 85 1pm), e.g., less than 25%, less than 20%, less than 15%, less than 12%, less than 10%, less than 8%, less than 5%, or less than 2.5%.

In some embodiments, the AM/AV fabric demonstrates an ATI filtration resistance less than 30% (at a flow rate of 60 1pm), e.g., less than 25%, less than 20%, less than 15%, less than 12%, less than 10%, less than 8%, less than 5%, or less than 4.4%.

In some embodiments, the AM/AV fabric demonstrates a pressure drop less than 5 mm H₂O/cm², as determined via EN 14683 (2019), e.g., less than 4.6 mm H₂O/cm², less than 4.5 mm H₂O/cm², less than 4.0 mm H₂O/cm², less than 3.5 mm H₂O/cm², less than 3.0 mm H₂O/cm², less than 2.7 mm H₂O/cm², less than 2.5 mm H₂O/cm², less than 2.0 mm H₂O/cm², less than 1.6 mm H₂O/cm², or less than 1.5 mm H₂O/cm²

In some cases, the AM/AV fabric demonstrates good absorption performance. Absorption performance may be determined as discussed in U.S. Pat. No. 9,944,539. For example, the absorption may be determined based on the amount of 320 centipoise gear lube oil per fabric unit weight that the respective fabrics absorb.

In some embodiments, the AM/AV fabric demonstrates an air permeability greater than 20 cfm/ft² at an MFP of at least 7 microns, e.g., greater than 22 cfm/ft², greater than 25 cfm/ft²,greater than 30 cfm/ft²,greater than 35 cfm/ft², greater than 40 cfm/ft², greater than 45 cfm/ft², greater than 50 cfm/ft², greater than 55 cfm/ft², or greater than 60 cfm/ft².

The filtration performance metrics discussed herein may, in some cases, be associated with the basis weights that are also disclosed herein. For example, the AM/AV fabric having a basis weight of may demonstrate an ATI filtration efficiency greater than 20% (at a flow rate of 85 1pm).

As has been noted, in some embodiments, the AM/AV fabrics may demonstrate AM/AV activity. In some cases, the AM/AV activity may be the result of the polymer composition from which the AM/AV fabrics or the layers/fabrics thereof or the fibers thereof are formed. For example, the AM/AV activity may be the result of forming the AM/AV fabrics from a polymer composition described herein. The fabrics will have efficacy against bacteria and/or viruses and/or fungi, among other microbials. The fabric may have efficacy against odor as well.

In some embodiments, the AM/AV fabrics exhibit permanent, e.g., near permanent, AM/AV properties. Said another way, the AM/AV properties of the polymer composition last for a prolonged period of time, e.g., longer than one or more day, longer than one or more week, longer than one or more month, or longer than one or more years.

The AM/AV properties may include any antimicrobial effect. In some embodiments, for example, the antimicrobial properties of the AM/AV fabric include limiting, reducing, or inhibiting infection of a microbe, e.g., a bacterium or bacteria. In some embodiments, the antimicrobial properties of the AM/AV fabric include limiting, reducing, or inhibiting growth and/or killing a bacterium. In some cases, the AM/AV fabric may limit, reduce, or inhibit both infection and growth of a bacterium.

The bacterium or bacteria affected by the antimicrobial properties of the AM/AV fabric are not particularly limited. In some embodiments, for example, the bacterium is a Streptococcus bacterium (e.g., Streptococcus pneumonia, Streptococcus pyogenes), a Staphylococcus bacterium (e.g., Staphylococcus aureus, Methicillin-resistant Staphylococcus aureus (MRSA)), a Peptostreptococcus bacterium (e.g., Peptostreptococcus anaerobius, Peptostreptococcus asaccharolyticus), a coli bacterium (e.g., Escherichia coli), or a Mycobacterium bacterium, (e.g., Mycobacterium tuberculosis), a Mycoplasma bacterium (e.g., Mycoplasma adleri, Mycoplasma agalactiae, Mycoplasma agassizii, Mycoplasma amphoriforme, Mycoplasma fermentans, Mycoplasma genitalium, Mycoplasma haemofelis, Mycoplasma hominis, Mycoplasma hyopneumoniae, Mycoplasma hyorhinis, Mycoplasma pneumoniae). In some embodiments, the antimicrobial properties include limiting, reducing, or inhibiting the infection or pathogenesis of multiple bacteria, e.g., a combination of two or more bacteria from the above list.

The antimicrobial activity of the AM/AV fabrics may be measured by the standard procedure defined by ISO 20743:2013. This procedure measures antimicrobial activity by determining the percentage of a given bacterium or bacteria, e.g. Staphylococcus aureus, inhibited by a tested fiber. In one embodiment, the AM/AV fabric inhibits the growth (growth reduction) of S. aureus in an amount ranging from 60% to 100%, e.g., from 60% to 99.999999%, from 60% to 99.99999%, from 60% to 99.9999%, from 60% to 99.999% from 60% to 99.999%, from 60% to 99.99%, from 60% to 99.9%, from 60% to 99%, from 60% to 98%, from 60% to 95%, from 65% to 99.999999%, from 65% to 99.99999%, from 65% to 99.9999%, from 65% to 99.999% from 65% to 99.999%, from 65% to 100%, from 65% to 99.99%, from 65% to 99.9%, from 65% to 99%, from 65% to 98%, from 65% to 95%, from 70% to 100%, from 70% to 99.999999%, from 70% to 99.99999%, from 70% to 99.9999%, from 70% to 99.999% from 70% to 99.999%, from 70% to 99.99%, from 70% to 99.9%, from 70% to 99%, from 70% to 98%, from 70% to 95%, from 75% to 100%, from 75% to 99.99%, from 75% to 99.9%, from 75% to 99.999999%, from 75% to 99.99999%, from 75% to 99.9999%, from 75% to 99.999% from 75% to 99.999%, from 75% to 99%, from 75% to 98%, from 75% to 95%, %, from 80% to 99.999999%, from 80% to 99.99999%, from 80% to 99.9999%, from 80% to 99.999% from 80% to 99.999%, from 80% to 100%, from 80% to 99.99%, from 80% to 99.9%, from 80% to 99%, from 80% to 98%, or from 80% to 95%. In terms of lower limits, the AM/AV fabric may inhibit greater than 60% growth of S. aureus, e.g., greater than 65%, greater than 70%, greater than 75%, greater than 80%, greater than 85%, greater than 90%, greater than 95%, greater than 98%, greater than 99%, greater than 99.9%, greater than 99.99%, greater than 99.999%, greater than 99.9999%, greater than 99.99999%, or greater than 99.999999%.

Klebsiella pneumoniae efficacy may also be determined using the aforementioned tests. In some embodiments, a product formed from the polymer composition inhibits the growth (growth reduction) of Klebsiella pneumoniae, as measured by the test mentioned above. Escherichia coli may be determined using ASTM E3160 (2018). The ranges and limits for Staph Aureus are applicable to Escherichia coli and/or Klebsiella pneumoniae and/or SARS-CoV-2 as well.

Efficacy may be characterized in terms of log reduction. In terms of Escherichia coli log reduction, the composition/fibers/fabrics may be determined via ASTM 3160 (2018) and may demonstrate a coli log reduction greater than 1.5, e.g., greater than 2.0, greater than 2.15, greater than 2.5, greater than 2.7, greater than 3.0, greater than 3.3, greater than 4.0, greater than 4.1, greater than 5.0, or greater than 6.0.

In terms of Staph Aureus log reduction, the composition/fibers/fabrics may be determined via ISO 20743:2013 and may demonstrate a microbial log reduction greater than 1.5, e.g., greater than 2.0, greater than 2.5, greater than 2.7, greater than 3.0, greater than 4.0, greater than 5.0, or greater than 6.0.

In terms of Klebsiella pneumoniae log reduction, the composition/fibers/fabrics may be determined via ISO 20743:2013 and may demonstrate a microbial log reduction greater than 1.5, e.g., greater than 2.0, greater than 2.5, greater than 2.6, greater than 3.0, greater than 4.0, greater than 5.0, or greater than 6.0.

In terms of SARS-CoV-2 log reduction, the composition/fibers/fabrics may be determined via ISO 18184:2019 and may demonstrate a viral log reduction greater than 1.5, e.g., greater than 2.0, greater than 2.5, greater than 2.6, greater than 1.7, greater than 3.0, greater than 4.0, greater than 5.0, or greater than 6.0.

The AM/AV properties may include any antiviral effect. In some embodiments, for example, the antiviral properties of the AM/AV fabric include limiting, reducing, or inhibiting infection of a virus. In some embodiments, the antiviral properties of the AM/AV fabric include limiting, reducing, or inhibiting pathogenesis of a virus. In some cases, the polymer composition may limit, reduce, or inhibit both infection and pathogenesis of a virus.

The virus affected by the antiviral properties of the AM/AV fabric is not particularly limited. In some embodiments, for example, the virus is an adenovirus, a herpesvirus, an ebolavirus, a poxvirus, a rhinovirus, a coxsackievirus, an arterivirus, an enterovirus, a morbillivirus, a coronavirus, an influenza A virus, an avian influenza virus, a swine-origin influenza virus, or an equine influence virus. In some embodiments, the antiviral properties include limiting, reducing, or inhibiting the infection or pathogenesis of one of virus, e.g., a virus from the above list. In some embodiments, the antiviral properties include limiting, reducing, or inhibiting the infection or pathogenesis of multiple viruses, e.g., a combination of two or more viruses from the above list.

In some cases, the virus is a coronavirus, e.g., severe acute respiratory syndrome coronavirus (SARS-CoV), Middle East respiratory syndrome coronavirus (MERS-CoV), or severe acute respiratory syndrome coronavirus 2 (SARS-CoV-2) (e.g., the coronavirus that causes COVID-19). In some cases, the virus is structurally related to a coronavirus.

In some cases, the virus is an influenza virus, such as an influenza A virus, an influenza B virus, an influenza C virus, or an influenza D virus, or a structurally related virus. In some cases, the virus is identified by an influenza A virus subtype, e.g., H1N1, H1N2, H2N2, H2N3, H3N1, H3N2, H3N8, H5N1, H5N2, H5N3, H5N6, H5N8, H5N9, H6N1, H7N1, H7N4, H7N7, H7N9, H9N2, or H10N7.

In some cases, the virus is a bacteriophage, such as a linear or circular single-stranded DNA virus (e.g., phi X 174 (sometimes referred to as ΦX174)), a linear or circular double-stranded DNA, a linear or circular single-stranded RNA, or a linear or circular double-stranded RNA. In some cases, the antiviral properties of the polymer composition may be measured by testing using a bacteriophage, e.g., phi X 174.

In some cases, the virus is an ebolavirus, e.g., Bundibugyo ebolavirus (BDBV), Reston ebolavirus (RESTV), Sudan ebolavirus (SUDV), Taï Forest ebolavirus (TAFV), or Zaire ebolavirus (EBOV). In some cases, the virus is structurally related to an ebolavirus.

The antiviral activity may be measured by a variety of conventional methods. For example, ISO 18184:2019 may be utilized to assess the antiviral activity. In one embodiment, the AM/AV fabric inhibits the pathogenesis (e.g., growth) of a virus in an amount ranging from 60% to 100%, e.g., from 60% to 99.999999%, from 60% to 99.99999%, from 60% to 99.9999%, from 60% to 99.999% from 60% to 99.999%, from 60% to 99.99%, from 60% to 99.9%, from 60% to 99%, from 60% to 98%, from 60% to 95%, from 65% to 99.999999%, from 65% to 99.99999%, from 65% to 99.9999%, from 65% to 99.999% from 65% to 99.999%, from 65% to 100%, from 65% to 99.99%, from 65% to 99.9%, from 65% to 99%, from 65% to 98%, from 65% to 95%, from 70% to 100%, from 70% to 99.999999%, from 70% to 99.99999%, from 70% to 99.9999%, from 70% to 99.999% from 70% to 99.999%, from 70% to 99.99%, from 70% to 99.9%, from 70% to 99%, from 70% to 98%, from 70% to 95%, from 75% to 100%, from 75% to 99.99%, from 75% to 99.9%, from 75% to 99.999999%, from 75% to 99.99999%, from 75% to 99.9999%, from 75% to 99.999% from 75% to 99.999%, from 75% to 99%, from 75% to 98%, from 75% to 95%, %, from 80% to 99.999999%, from 80% to 99.99999%, from 80% to 99.9999%, from 80% to 99.999% from 80% to 99.999%, from 80% to 100%, from 80% to 99.99%, from 80% to 99.9%, from 80% to 99%, from 80% to 98%, or from 80% to 95%. In terms of lower limits, a AM/AV fabric may inhibit greater than 60% of pathogenesis of the virus, e.g., greater than 65%, greater than 70%, greater than 75%, greater than 80%, greater than 85%, greater than 90%, greater than 95%, greater than 98%, greater than 99%, greater than 99.9%, greater than 99.99%, greater than 99.999%, greater than 99.9999%, greater than 99.99999%, or greater than 99.999999%.

In addition, the use of the polymer compositions disclosed herein provides for biocompatibility advantages. For example, the overall softness of the aforementioned fabrics, along with the compositional characteristics, provides for unexpected reductions in irritation and sensitivity. Beneficially, the disclosed fibers and fabric do not demonstrate the biocompatibility issues associated with conventional fabrics, e.g., those that employ metals with toxicity problems such as silver.

### Method of Forming Fibers and Nonwoven Fabrics

As described herein, the fibers or fabrics of the AM/AV fabric are made by forming the AM/AV polymer composition into the fibers, which are arranged to form the fabric or structure.

As noted above, the process comprises the steps of intermingling AM/AV fibers (comprising the aforementioned AM/AV polymer composition) and base fibers (comprising the aforementioned base polymer composition) to form a fabric web. The process may further comprise the step of charging the fabric web to form the AM/AV fabric, which optionally has some degree of electrical charge. The AM/AV fabric demonstrates the aforementioned synergistic combination of performance features.

The intermingling of the base fibers and the AM/AV fibers may be achieved in various ways. In some cases, the intermingling is achieved by forming, e.g., meltblowing, the AM/AV polymer composition to form the AM/AV fibers and forming, e.g., meltblowing the base polymer composition to form the base fibers. The equipment used for the formation of the fibers may be configured such that the fibers, as they are formed, are directed toward one another, thus directing the fibers to intermingle.

In some cases, the AM/AV fibers are meltblown from AM/AV equipment and the base fibers are meltblown from separate base fiber equipment. The two pieces of equipment may be separate from one another. In some cases, the fibers are blown into one another, which advantageously promotes the intermingling of the fibers.

The charging step is particularly effective when the disclosed AM/AV polymer compositions are utilized, e.g., with the inclusion of a charge agent. The inclusion of the charge agent may provide for a higher degree of charge across the entirety of the AM/AV fabric.

In some embodiments, the process for preparing fibers having permanent AM/AV properties from the polyamide composition includes preparing an aqueous monomer solution, adding less than 20,000 wppm of one or more AM/AV compounds dispersed within the aqueous monomer solution, e.g., less than 17,500 wppm, less than 17,000 wppm, less than 16,500 wppm, less than 16,000 wppm, less than 15,500 wppm, less than 15,000 wppm, less than 12,500 wppm, less than 10,000 wppm, less than 5000 wppm, less than less than 4000 wppm, less than 3000 wppm, less than 2000 wppm, less than 1000 wppm, or less than 500 wppm, polymerizing the aqueous monomer solution to form a polymer melt, and spinning the polymer melt to form an AM/AV fiber. In this embodiment, the polyamide composition comprises the resultant aqueous monomer solution after the metallic compound(s) are added.

In some embodiments, the process includes preparing an aqueous monomer solution. The aqueous monomer solution may comprise amide monomers. In some embodiments, the concentration of monomers in the aqueous monomer solution is less than 60 wt%, e.g., less than 58 wt%, less than 56.5 wt%, less than 55 wt%, less than 50 wt%, less than 45 wt%, less than 40 wt%, less than 35 wt%, or less than 30 wt%. In some embodiments, the concentration of monomers in the aqueous monomer solution is greater than 20 wt%, e.g., greater than 25 wt%, greater than 30 wt%, greater than 35 wt%, greater than 40 wt%, greater than 45 wt%, greater than 50 wt%, greater than 55 wt%, or greater than 58 wt%. In some embodiments, the concentration of monomers in the aqueous monomer solution is in a range from 20 wt% to 60 wt%, e.g., from 25 wt% to 58 wt%, from 30 wt% to 56.5 wt%, from 35 wt% to 55 wt%, from 40 wt% to 50 wt%, or from 45 wt% to 55 wt%. The balance of the aqueous monomer solution may comprise water and/or additional additives. In some embodiments, the monomers comprise amide monomers including a diacid and a diamine, i.e., nylon salt.

In some embodiments, the aqueous monomer solution is a nylon salt solution. The nylon salt solution may be formed by mixing a diamine and a diacid with water. For example, water, diamine, and dicarboxylic acid monomer are mixed to form a salt solution, e.g., mixing adipic acid and hexamethylene diamine with water. In some embodiments, the diacid may be a dicarboxylic acid and may be selected from the group consisting of oxalic acid, malonic acid, succinic acid, glutaric acid, pimelic acid, adipic acid, suberic acid, azelaic acid, sebacic acid, undecanedioic acid, dodecandioic acid, maleic acid, glutaconic acid, traumatic acid, and muconic acid, 1,2- or 1,3-cyclohexane dicarboxylic acids, 1,2- or 1,3 -phenyl enediacetic acids, 1,2- or 1,3- cyclohexane diacetic acids, isophthalic acid, terephthalic acid, 4,4′-oxybisbenzoic acid, 4,4-benzophenone dicarboxylic acid, 2,6-napthalene dicarboxylic acid, p-t-butyl isophthalic acid and 2,5-furandicarboxylic acid, and mixtures thereof. In some embodiments, the diamine may be selected from the group consisting of ethanol diamine, trimethylene diamine, putrescine, cadaverine, hexamethyelene diamine, 2-methyl pentamethylene diamine, heptamethylene diamine, 2-methyl hexamethylene diamine, 3 -methyl hexamethylene diamine, 2,2-dimethyl pentamethylene diamine, octamethylene diamine, 2,5-dimethyl hexamethylene diamine, nonamethylene diamine, 2,2,4- and 2,4,4-trimethyl hexamethylene diamines, decamethylene diamine, 5-methylnonane diamine, isophorone diamine, undecamethylene diamine, dodecamethylene diamine, 2,2,7,7-tetramethyl octamethylene diamine, bis(p-aminocyclohexyl)methane, bis(aminomethyl)norbornane, C2-C16 aliphatic diamine optionally substituted with one or more C1 to C4 alkyl groups, aliphatic polyether diamines and furanic diamines, such as 2,5-bis(aminomethyl)furan, and mixtures thereof. In preferred embodiments, the diacid is adipic acid and the diamine is hexamethylene diamine which are polymerized to form PA6,6.

It should be understood that the concept of producing a polyamide from diamines and diacids also encompasses the concept of other suitable monomers, such as, aminoacids or lactams. Without limiting the scope, examples of aminoacids can include 6-aminohaxanoic acid, 7-aminoheptanoic acid, 11-aminoundecanoic acid, 12-aminododecanoic acid, or combinations thereof. Without limiting the scope of the disclosure, examples of lactams can include caprolactam, enantholactam, lauryllactam, or combinations thereof. Suitable feeds for the disclosed process can include mixtures of diamines, diacids, aminoacids and lactams.

After the aqueous monomer solution is prepared, a metallic compound (e.g., a zinc compound, a copper compound, and/or a silver compound) is added to the aqueous monomer solution to form the polyamide composition. In some embodiments, less than 20,000 wppm of the metallic compound is dispersed within the aqueous monomer solution. In some aspects, further additives, e.g., additional AM/AV agents, are added to the aqueous monomer solution. Optionally, phosphorus (e.g., a phosphorus compound) is added to the aqueous monomer solution.

In some cases, the polyamide composition is polymerized using a conventional melt polymerization process. In one aspect, the aqueous monomer solution is heated under controlled conditions of time, temperature, and pressure to evaporate water, effect polymerization of the monomers and provide a polymer melt. In some aspects, the particular weight ratio of zinc to phosphorus may advantageously promote binding of zinc within the polymer, reduce thermal degradation of the polymer, and enhance its dyeability.

In one embodiment, a nylon is prepared by a conventional melt polymerization of a nylon salt. Typically, the nylon salt solution is heated under pressure, e.g. 250 psig/1825 × 10³ n/m², to a temperature of, for example, about 245° C. Then the water vapor is exhausted off by reducing the pressure to atmospheric pressure while increasing the temperature to, for example, about 270° C. Before polymerization, zinc and, optionally, phosphorus be added to the nylon salt solution. The resulting molten nylon is held at this temperature for a period of time to bring it to equilibrium prior to being extruded into a fiber. In some aspects, the process may be carried out in a batch or continuous process.

In some embodiments, during melt polymerization, AM/AV compound, e.g., zinc oxide is added to the aqueous monomer solution. The AM/AV fiber may comprise a polyamide that is made in a melt polymerization process and not in a master batch process. In some aspects, the resulting fiber has permanent AM/AV properties. The resulting fiber can be used in the topsheet layer and/or the pad layer of the AM/AV fabric.

The AM/AV agent may be added to the polyamide during melt polymerization, for example as a master batch or as a powder added to the polyamide pellets, and thereafter, the fiber may be formed from spinning. The fibers are then formed into a nonwoven structure.

In some aspects, the AM/AV nonwoven structure is melt blown. Melt blowing is advantageously less expensive than electrospinning. Melt blowing is a process type developed for the formation of microfibers and nonwoven webs. Until recently, microfibers have been produced by melt blowing. Now, nanofibers may also be formed by melt blowing. The nanofibers are formed by extruding a molten thermoplastic polymeric fabric, or polyamide, through a plurality of small holes. The resulting molten threads or filaments pass into converging high velocity gas streams which attenuate or draw the filaments of molten polyamide to reduce their diameters. Thereafter, the melt blown nanofibers are carried by the high velocity gas stream and deposited on a collecting surface, or forming wire, to form a nonwoven web of randomly disbursed melt blown nanofibers. The formation of nanofibers and nonwoven webs by melt blowing is well known in the art. See, e.g., U.S. Pat. Nos. 3,704,198; 3,755,527; 3,849,241; 3,978,185; 4,100,324; and 4,663,220.

As is well known, electrospinning has many fabrication parameters that may limit spinning certain fabrics. These parameters include: electrical charge of the spinning fabric and the spinning fabric solution; solution delivery (often a stream of fabric ejected from a syringe); charge at the jet; electrical discharge of the fibrous membrane at the collector; external forces from the electrical field on the spinning jet; density of expelled jet; and (high) voltage of the electrodes and geometry of the collector. In contrast, the aforementioned nanofibers and products are advantageously formed without the use of an applied electrical field as the primary expulsion force, as is required in an electrospinning process. Thus, the polyamide is not electrically charged, nor are any components of the spinning process. Importantly, the dangerous high voltage necessary in electrospinning processes, is not required with the presently disclosed processes/products. In some embodiments, the process is a non-electrospin process and resultant product is a non-electrospun product that is produced via a non-electrospin process.

Another embodiment of making the nanofiber nonwovens is by way of 2-phase spinning or melt blowing with propellant gas through a spinning channel as is described generally in U.S. Pat. No. 8,668,854. This process includes two phase flow of polymer or polymer solution and a pressurized propellant gas (typically air) to a thin, preferably converging channel. The channel is usually and preferably annular in configuration. It is believed that the polymer is sheared by gas flow within the thin, preferably converging channel, creating polymeric film layers on both sides of the channel. These polymeric film layers are further sheared into nanofibers by the propellant gas flow. Here again, a moving collector belt may be used and the basis weight of the nanofiber nonwoven is controlled by regulating the speed of the belt. The distance of the collector may also be used to control fineness of the nanofiber nonwoven.

Beneficially, the use of the aforementioned polyamide precursor in the melt spinning process provides for significant benefits in production rate, e.g., at least 5% greater, at least 10% greater, at least 20% greater, at least 30% greater, at least 40% greater. The improvements may be observed as an improvement in area per hour versus a conventional process, e.g., another process that does not employ the features described herein. In some cases, the production increase over a consistent period of time is improved. For example, over a given time period, e.g,, one hour, of production, the disclosed process produces at least 5% more product than a conventional process or an electrospin process, e.g., at least 10% more, at least 20% more, at least 30% more, or at least 40% more.

Still yet another methodology which may be employed is melt blowing. Melt blowing involves extruding the polyamide into a relatively high velocity, typically hot, gas stream. To produce suitable nanofibers, careful selection of the orifice and capillary geometry as well as the temperature is required as is seen in: Hassan et al., J Membrane Sci., 427, 336-344, 2013 and Ellison et al., Polymer, 48 (11), 3306-3316, 2007, and, International Nonwoven Journal, Summer 2003, pg 21-28.

U.S. Pat. 7,300,272 (incorporated herein by reference) discloses a fiber extrusion pack for extruding molten fabric to form an array of nanofibers that includes a number of split distribution plates arranged in a stack such that each split distribution plate forms a layer within the fiber extrusion pack, and features on the split distribution plates form a distribution network that delivers the molten fabric to orifices in the fiber extrusion pack. Each of the split distribution plates includes a set of plate segments with a gap disposed between adjacent plate segments. Adjacent edges of the plate segments are shaped to form reservoirs along the gap, and sealing plugs are disposed in the reservoirs to prevent the molten fabric from leaking from the gaps. The sealing plugs can be formed by the molten fabric that leaks into the gap and collects and solidifies in the reservoirs or by placing a plugging fabric in the reservoirs at pack assembly. This pack can be used to make nanofibers with a melt blowing system described in the patents previously mentioned. The systems and method of U.S. Pat. No. 10,041,188 (incorporated herein by reference) are also exemplary.

In one embodiment, a process for preparing the AM/AV fabric is disclosed. The process comprising the step of forming a (precursor) polyamide (preparation of monomer solutions are well known), e.g., by preparing an aqueous monomer solution. During preparation of the precursor, a metallic compound is added (as discussed herein). In some cases, the metallic compound is added to (and dispersed in) the aqueous monomer solution. Phosphorus may also be added. In some cases, the precursor is polymerized to form a polyamide composition. The process further comprises the steps of forming polyamide fibers and forming the AM/AV polyamide fibers into a structure. In some cases, the polyamide composition is melt spun, spunbonded, electrospun, solution spun, or centrifugally spun.

### EXAMPLES

Bicomponent AM/AV fabrics of Examples 1-13 were prepared by side-by-side melt-spinning an AM/AV polymer composition in one feed and a base polymer composition in the other to form the resultant AM/AV fabrics. Comparative Example monocomponent fabrics A - E were prepared using single feed melt-spinning that employed either the AM/AV polymer composition or the base polymer composition. Comparative Examples A - E did not employ both AM/AV polymer and base polymer composition and, as such, yielded fabrics comprising only a single type of fibers.

The AM/AV polymer comprised PA66 (500 BD PA) and AM/AV compound(s); the base polymer composition comprised polypropylene (Braskem; 1200 melt flow index) (with no AM/AV compound).The compositions of AM/AV polymer composition and the base polymer composition are shown in Table 1. Additional details of the fabrics, e.g., basis weight or average particle diameter, are also provided in Table 1. The fabrics were then charged using a Corotec electret unit set at 0.5 kw.

TABLE 1

Fabric Compositions and Characteristics

| Example | AM/AV % | Base % | Zinc, ppm | Copper, ppm | Target Basis Wt, gsm | Mean Flow Pore Size, microns | Avg. Fiber Diam., microns |
|---|---|---|---|---|---|---|---|
| Ex. 1 | 60 | 40 | 423 | 21 | 10 | 14.1 | 2.15 |
| Ex. 2 | 50 | 50 | 396 | 20 | 10 | 13.4 | 1.82 |
| Ex. 3 | 40 | 60 | 367 | 39 | 10 | 11.9 | 1.69 |
| Ex. 4 | 60 | 40 | 403 | 20 | 17 | 10.4 | 1.93 |
| Ex. 5 | 50 | 50 | 385 | 20 | 17 | 10.6 | 1.86 |
| Ex. 6 | 40 | 60 | 338 | 17 | 17 | 10.5 | 1.72 |
| Ex. 7 | 60 | 40 | 394 | 21 | 20 | 9.6 | 2.07 |
| Ex. 8 | 50 | 50 | 347 | 18 | 20 | 9.7 | 1.81 |
| Ex. 9 | 40 | 60 | 337 | 17 | 20 | 8.6 | 1.87 |
| Ex. 10 | 60 | 40 | 376 | 19 | 30 | 9.5 | 1.95 |
| Ex. 11 | 50 | 50 | 357 | 19 | 30 | 8.5 | 1.91 |
| Ex. 12 | 40 | 60 | 284 | 15 | 30 | 8.7 | 1.69 |
| Ex. 13 | 20 | 80 | 231 | 12 | 30 | 8.1 | 1.67 |
| Comp. Ex. A | 100 | 0 | 531 | 30 | 11 | 15.0 | N/A |
| Comp. Ex. B | 0 | 100 | 0 | 0 | 17 | 13.5 | N/A |
| Comp. Ex. C | 100 | 0 | 605 | 27 | 17 | 7.3 | N/A |
| Comp. Ex. D | 0 | 100 | 0 | 0 | 30 | 8.6 | N/A |
| Comp. Ex. E | 100 | 0 | 702 | 31 | 30 | 7.9 | N/A |

The fabrics were tested for air permeability, pressure drop, ATI filtration efficiency (85 liters per minute), ATI filtration resistance (at 85 liters per minute), and PFE (at 31.8 liters per minute). The results are shown in Table 2.

TABLE 2

Performance

| Example | Air Perm., cfm/ft² | P Drop, mmH₂O/ cm² | ATI Filt. Eff. (85), % | ATI Filt. Eff. (60), % | ATI Filt. Res. (85), % | ATI Filt. Res. (60), % | PFE (31.8), % |
|---|---|---|---|---|---|---|---|
| Ex. 1 | 169.7 | 0.8 | 35.2 | 39.3 | 2.1 | 1.4 | 68.9 |
| Ex. 2 | 169.0 | 1.0 | 36.9 | 41.5 | 2.2 | 1.4 | 69.3 |
| Ex. 3 | 126.0 | 1.4 | 41.7 | 44.6 | 2.9 | 2.1 | 66.2 |
| Ex. 4 | 84.3 | 1.8 | 50.1 | 58.4 | 3.7 | 3.1 | 82.0 |
| Ex. 5 | 77.7 | 2.0 | 51.2 | 61.4 | 4.0 | 3.2 | 79.6 |
| Ex. 6 | 67.9 | 2.2 | 55.8 | 64.6 | 4.7 | 4.2 | 82.1 |
| Ex. 7 | 70.7 | 2.1 | 56.8 | 62.5 | 5.1 | 3.9 | 87.4 |
| Ex. 8 | 62.8 | 2.3 | 57.3 | 64.2 | 5.5 | 3.9 | 85.2 |
| Ex. 9 | 58.6 | 2.6 | 62.9 | 69.1 | 6.4 | 5.0 | 86.5 |
| Ex. 10 | 44.8 | 3.7 | 64.3 | 71.4 | 7.9 | 5.7 | 88.1 |
| Ex. 11 | 41.9 | 3.6 | 64.8 | | 8.3 | -- | 89.8 |
| Ex. 12 | 38.5 | 3.9 | 70.4 | 77.2 | 10.0 | 7.6 | 90.3 |
| Ex. 13 | 40.4 | 3.9 | 61.0 | 64.7 | 8.6 | 6.6 | 83.2 |
| Comp. Ex. A | 134.0 | 1.0 | 12.1 | -- | 2.5 | -- | 33.5 |
| Comp. Ex. B | 97.0 | 1.6 | 58.4 | 63.3 | 4.4 | 3.0 | 85.0 |
| Comp. Ex. C | 56.0 | 2.5 | 49.2 | 45.5 | 8.2 | 5.2 | 57.1 |
| Comp. Ex. D | 32.0 | 3.5 | 83.2 | 89.1 | 11.4 | 7.6 | 96.0 |
| Comp. Ex. E | 30.0 | 4.6 | 49.7 | -- | 11.7 | -- | 73.5 |

As shown in Table 2, the combination of base fibers and AM/AV leads to synergistic combinations of performance features, e.g., AM/AV performance in combination with filtration performance. Conventional single-component AM/AV fabrics have been found to lack filtration performance. The addition of the disclosed base fibers has been found to provide for the synergistic combinations of performance features while not detracting from the overall AM/AV performance. For example, when Examples and Comparative Examples having the same basis weight are compared, a significant improvement in particle filtration efficiency is demonstrated, compare Examples 1 - 3 and Comparative Example A (66, 69, 69 vs. 33.5 → ∼100% improvement). The Examples beneficially also demonstrated the AM/AV performance disclosed herein, while the AM/AV performance of the Comparative Examples with only base fibers was poor or non-existent.

As another example, Examples 1 - 3 demonstrated significantly better ATI filtration efficiency (85 1pm) vs. Comparative Example A (35 - 42 vs 12 → ∼105+% improvement), with all samples having 10 gsm basis weights. The aforementioned AM/AV performance improvements were again demonstrated. Table 2 is replete with additional examples of unexpected synergistic combinations.

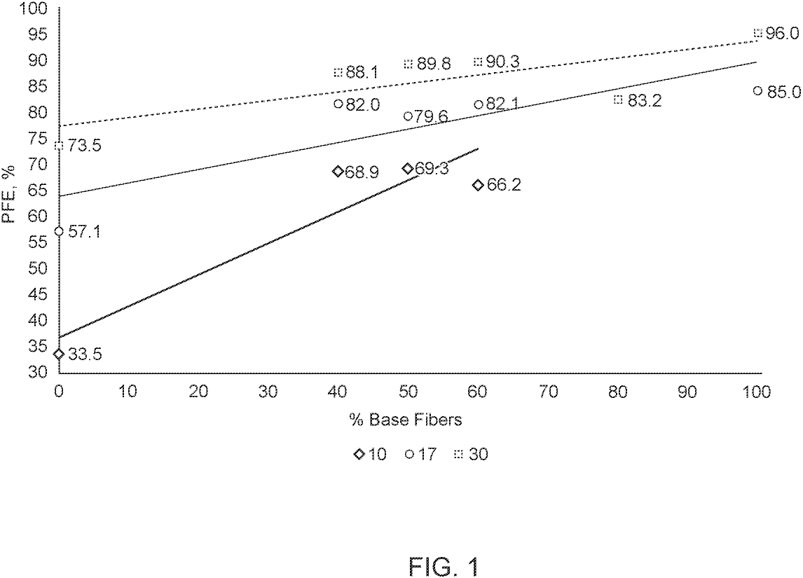

The data of Table 2 were captured graphically in FIGS. 1 - 3.

FIG. 1 shows particle filtration efficiency performance as a function of base fiber content at various basis weights. The presence of the AM/AV fibers in the Examples provides for demonstrated the AM/AV performance disclosed herein. The combination of AM/AV fibers and base fibers improves strikes an advantageous balance of particle filtration efficiency and AM/AV performance. Particle filtration efficiency performance with only AM/AV fibers (Comparative Examples) is poor, and AM/AV performance with only base fibers (Comparative Examples) was again poor or non-existent.

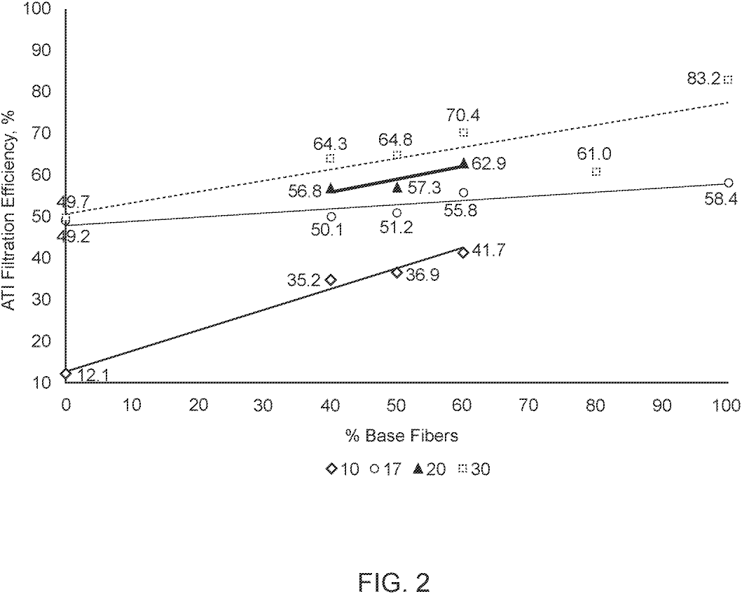

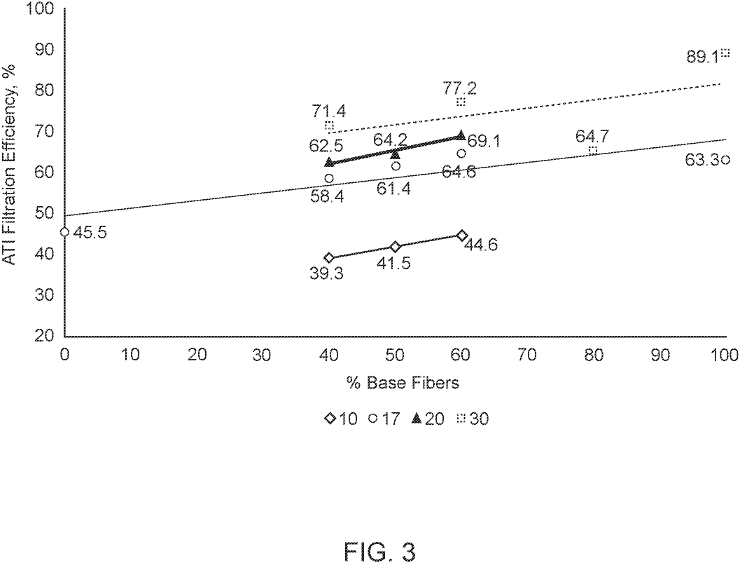

FIGS. 2 and 3 show ATI filtration efficiency performance (at 85 1pm and 60 1pm, respectively) as a function of base fiber content at various basis weights. The presence of the AM/AV fibers in the Examples provides for demonstrated the AM/AV performance disclosed herein. The combination of AM/AV fibers and base fibers improves strikes an advantageous balance of ATI filtration efficiency and AM/AV performance. Particle filtration efficiency performance with only AM/AV fibers (Comparative Examples) is poor, and AM/AV performance with only base fibers (Comparative Examples) was again poor or non-existent. Embodiments

As used below, any reference to a series of embodiments is to be understood as a reference to each of those embodiments disjunctively (e.g., “Embodiments 1-4” is to be understood as “Embodiments 1, 2, 3, or 4”).

Embodiment 1 relates to an AM/AV fabric, comprising base fibers comprising a base polymer composition; and AM/AV fibers comprising an AM/AV polymer composition comprising an AM/AV polymer and an AM/AV compound; wherein base fibers and the AM/AV fibers are intermingled with one another; and wherein the fabric demonstrates an Escherichia coli efficacy log reduction greater than 4.0, as measured in accordance with ASTM E3160 (2018) and a particle filtration efficiency greater than 35%.

Embodiment 2 relates to embodiment 1, wherein the base fibers have a base fiber charge.

Embodiment 3 relates to embodiment(s) 1 or 2, wherein the AM/AV fibers have an AM/AV fiber charge.

Embodiment 4 relates to embodiment(s) 1 - 3, wherein the AM/AV fibers have no charge.

Embodiment 5 relates to embodiment(s) 1 - 4, wherein the base fiber charge is less than the AM/AV fiber charge.

Embodiment 6 relates to embodiment(s) 1 - 5, wherein the fabric, comprises greater than 25 wt% base fibers.

Embodiment 7 relates to embodiment(s) 1 - 6, wherein the base polymer comprises polypropylene and the AM/AV polymer comprises polyamide.

Embodiment 8 relates to embodiment(s) 1 - 7, wherein the AM/AV compound comprises zinc or copper or a combination thereof.

Embodiment 9 relates to embodiment(s) 1 - 8, wherein the AM/AV compound comprises a zinc compound.

Embodiment 10 relates to embodiment(s) 1 - 9, wherein the AM/AV fabric has a basis weight greater than 5 gsm.

Embodiment 11 relates to embodiment(s) 1 - 10, wherein the AM/AV fibers comprise a supplemental polymer different from the AM/AV polymer.

Embodiment 12 relates to embodiment(s) 1 - 11, wherein the base polymer composition comprises a charge agent, preferably a stearate and/or a wax.

Embodiment 13 relates to embodiment(s) 1 - 12, wherein the AM/AV polymer composition comprises a charge agent, preferably a stearate and/or a wax.

Embodiment 14 relates to embodiment(s) 1 - 13, wherein the fabric demonstrates an ATI filtration efficiency greater than 20%.

Embodiment 15 relates to embodiment(s) 1 - 14, wherein the fabric demonstrates a pressure drop greater than 1 mm H₂O/cm².

Embodiment 16 relates to embodiment(s) 1 - 15, wherein the fabric demonstrates an air permeability greater than 20 cfm/ft² at an MFP of at least 7 microns.

Embodiment 17 relates to a process for producing an AM/AV fabric, the process comprising: intermingling AM/AV fibers comprising an AM/AV polymer composition and base fibers comprising a base polymer composition and to form a fabric web; charging the fabric web to form the AM/AV fabric; wherein the AM/AV fabric demonstrates an Escherichia coli efficacy log reduction greater than 4.0, as measured in accordance with ASTM E3160 (2018) and a particle filtration efficiency greater than 35%.

Embodiment 18 relates to embodiment 17, further comprising blowing the AM/AV polymer composition to form the AM/AV fibers; and blowing the base polymer composition to form the base fibers; wherein the blowing of the fibers effectuates the intermingling.

Embodiment 19 relates to embodiment 18, wherein the base fibers have a base fiber charge and the AM/AV fibers have an AM/AV fiber charge, and wherein the base fiber charge is less than the AM/AV fiber charge.

Embodiment 20 relates to embodiment(s) 18 or 19, wherein the AM/AV fibers comprise a supplemental polymer different from the AM/AV polymer.

Embodiment 21 relates to embodiment(s) 18 - 20, wherein the base polymer composition comprises a charge agent, preferably a stearate and/or a wax.

Embodiment 22 relates to embodiment(s) 18 - 21, wherein the AM/AV polymer composition comprises a charge agent, preferably a stearate and/or a wax.

Embodiment 23 relates to an AM/AV fabric, comprising: base fibers comprising a base polymer composition comprising polypropylene; and AM/AV fibers comprising an AM/AV polymer composition comprising an AM/AV polymer comprising polyamide and an AM/AV compound comprising zinc or copper or a combination thereof and an optional supplemental polymer comprising an olefin polymer; wherein base fibers and the AM/AV fibers are intermingled with one another; and wherein the fabric demonstrates an Escherichia coli efficacy log reduction greater than 4.0, as measured in accordance with ASTM E3160 (2018) and a particle filtration efficiency greater than 35%.

We claim:

1. An AM/AV fabric, comprising:
base fibers comprising a base polymer composition; and
AM/AV fibers comprising an AM/AV polymer composition comprising an AM/AV polymer and an AM/AV compound;
wherein base fibers and the AM/AV fibers are intermingled with one another; and
wherein the fabric demonstrates an Escherichia coli efficacy log reduction greater than 4.0, as measured in accordance with ASTM E3160 (2018) and a particle filtration efficiency greater than 35%.

2. The fabric of claim 1, wherein the base fibers have a base fiber charge.

3. The fabric of claim 1, wherein the AM/AV fibers have an AM/AV fiber charge.

4. The fabric of claim 1, wherein the AM/AV fibers have no charge.

5. The fabric of claim 3, wherein the base fiber charge is less than the AM/AV fiber charge.

6. The fabric of claim 1, wherein the fabric, comprises greater than 25 wt% base fibers.

7. The fabric of claim 1, wherein the base polymer comprises polypropylene and the AM/AV polymer comprises polyamide.

8. The fabric of claim 1, wherein the AM/AV compound comprises zinc or copper or a combination thereof.

9. The fabric of claim 1, wherein the AM/AV compound comprises a zinc compound.

10. The fabric of claim 1, wherein the AM/AV fibers comprise a supplemental polymer different from the AM/AV polymer.

11. The fabric of claim 1, wherein the base polymer composition or the AM/AV polymer composition comprises a charge agent.

12. The fabric of claim 1, wherein the fabric demonstrates an ATI filtration efficiency greater than 20% at an 85 1pm flow rate.

13. The fabric of claim 1, wherein the fabric demonstrates a pressure drop greater than 1 mm H₂O/cm².

14. The fabric of claim 1, wherein the fabric demonstrates an air permeability greater than 20 cfm/ft² at a mean flow pore size of at least 7 microns.

15. A process for producing an AM/AV fabric, the process comprising:
intermingling AM/AV fibers comprising an AM/AV polymer composition and base fibers comprising a base polymer composition and to form a fabric web;
charging the fabric web to form the AM/AV fabric;
wherein the AM/AV fabric demonstrates an Escherichia coli efficacy log reduction greater than 4.0, as measured in accordance with ASTM E3160 (2018) and a particle filtration efficiency greater than 35%.

16. The process of claim 15, further comprising:
blowing the AM/AV polymer composition to form the AM/AV fibers; and
blowing the base polymer composition to form the base fibers;
wherein the blowing of the fibers effectuates the intermingling.

17. The process of claim 15, wherein the base fibers have a base fiber charge and the AM/AV fibers have an AM/AV fiber charge, and wherein the base fiber charge is less than the AM/AV fiber charge.

18. The process of claim 15, wherein the AM/AV fibers comprise a supplemental polymer different from the AM/AV polymer.

19. The process of claim 15, wherein the base polymer composition or the AM/AV polymer composition comprises a charge agent.

20. An AM/AV fabric, comprising:
base fibers comprising a base polymer composition comprising polypropylene; and
AM/AV fibers comprising an AM/AV polymer composition comprising an AM/AV polymer comprising polyamide and an AM/AV compound comprising zinc or copper or a combination thereof and an optional supplemental polymer comprising an olefin polymer;
wherein base fibers and the AM/AV fibers are intermingled with one another; and
wherein the fabric demonstrates an Escherichia coli efficacy log reduction greater than 4.0, as measured in accordance with ASTM E3160 (2018) and a particle filtration efficiency greater than 35%.
